(19) United States
(12) Patent Application Publication
(10) Pub. No.: US 2021/0264497 A1
(43) Pub. Date: Aug. 26, 2021

(54) METHODS AND SYSTEMS FOR AGGREGATE CONSUMER-BEHAVIOR SIMULATION AND PREDICTION BASED ON AUTOMATED FLIGHT-RECOMMENDATION-AND-BOOKING SYSTEMS

(71) Applicant: THOTH, Inc., Bellevue, WA (US)

(72) Inventors: Bayram Annakov, Bellevue, WA (US); Anatoly Zaytsev, Bellevue, WA (US)

(73) Assignee: THOTH, Inc., Bellevue, WA (US)

(21) Appl. No.: 17/180,501

(22) Filed: Feb. 19, 2021

Related U.S. Application Data
(60) Provisional application No. 62/979,589, filed on Feb. 21, 2020.

(51) Int. Cl. G06Q 30/06; G06N 5/04; G06Q 10/02

(52) U.S. Cl. CPC G06Q 30/0631; G06Q 10/02; G06N 5/04

(57) ABSTRACT

The current document is directed to methods and systems, including an automated flight-recommendation-and-booking system that provide accurate, short lists of flights that best match a user's preferences and flight parameters specified by the user. In addition, the automated flight-recommendation-and-booking system learns, over time, to provide the most desirable flights to each user. The currently disclosed systems continuously monitor and store detailed information with regard to users' interactions with the systems, flight information, and other types of information that can be used to more accurately identify suitable flights for particular users. Furthermore, the currently disclosed systems continuously store information about user interactions as well as information about airlines, flights offered by airlines, and other types of information relevant to air travel in order to be able to subsequently find and present information about flights that closely match each user's preferences and flight parameters. The stored information, and additional information inferred by analyzing the stored information, can be used, by the currently disclosed systems, to model, simulate, and predict future behavior of airline customers, including the responses of airline customers to newly provided flights, price changes, addition of services and amenities, and other such changes. This, in turn, allows airlines and business analysts to rationally plan and develop new and improved business opportunities.

### CROSS-REFERENCE TO RELATED APPLICATION

This application claims the benefit of Provisional Application No. 62/979,589, filed Feb. 21, 2021.

### TECHNICAL FIELD

The current document is directed to automated airline-flight-reservation systems and, in particular, to methods and systems that provide, to airlines, analysts, and other users, accurate simulations and predictions of airline-customer behavior.

### BACKGROUND

With the advent of the Internet and powerful personal processor-controlled computers, smart phones, and other computing devices, older methods for finding and booking flights, including in-person and telephone interactions with travel agents, have been largely supplanted by automated airline-flight-reservation Internet services. While, in many ways, these automated services are more convenient and time efficient, they generally fail to provide the personalized services that were previously provided as a result of long-term relationships between travel agents and their clients. Many of the automated airline-flight-reservation systems provide awkward and complex user interfaces, for example, and tend to provide a far greater number of flight selections and information than desired by users, who often would prefer to receive only a small number of flight selections that accurately reflect their preferences and who would often prefer not to be required to tediously input large numbers of parameters and invoke many different types of search filters in order to direct the automated airline-flight-reservation systems to search for desirable flights. For this reason, developers, owners and administrators, and users of automated airline-flight-reservation services continue to seek better, more effective, and more efficient implementations and user interfaces. In addition, airlines, business analysts, and others who seek information about the behavior of airline customers continue to seek methods and systems by which the data, collectible by automated airline-flight-reservation services, can be used to provide information about the aggregate behavior of airline customers, including simulating aggregate behavior of airline customers and predicting aggregate behavior of airline customers.

### SUMMARY

The current document is directed to methods and systems, including an automated flight-recommendation-and-booking system, that provide accurate, short lists of flights that best match a user's preferences and flight parameters specified by the user. In addition, the automated flight-recommendation-and-booking system learns, over time, to provide the most desirable flights to each user. The currently disclosed systems continuously monitor and store detailed information with regard to users' interactions with the systems, flight information, and other types of information that can be used to more accurately identify suitable flights for particular users. Furthermore, the currently disclosed systems continuously store information about user interactions as well as information about airlines, flights offered by airlines, and other types of information relevant to air travel in order to be able to subsequently find and present information about flights that closely match each user's preferences and flight parameters. The stored information, and additional information inferred by analyzing the stored information, can be used, by the currently disclosed systems, to model, simulate, and predict future behavior of airline customers, including the responses of airline customers to newly provided flights, price changes, addition of services and amenities, and other such changes. This, in turn, allows airlines and business analysts to rationally plan and develop new and improved business opportunities.

### BRIEF DESCRIPTION OF THE DRAWINGS

FIG. 1 provides a general architectural diagram for various types of computers.

FIG. 2 illustrates an Internet-connected distributed computer system.

FIG. 3 illustrates cloud computing.

FIG. 4 illustrates generalized hardware and software components of a general-purpose computer system, such as a general-purpose computer system having an architecture similar to that shown in FIG. 1.

FIGS. 5A-D illustrate several types of virtual machine and virtual-machine execution environments.

FIG. 6 illustrates the environments in which the currently disclosed methods and systems operate.

FIG. 7 illustrates the currently disclosed methods and systems at a relatively high level.

FIG. 8 illustrates an example database that can be used, by certain implementations of the currently disclosed methods and systems, for persistently storing data.

FIGS. 9A-G provide control-flow diagram to illustrate certain aspects of one implementation of the currently disclosed flight-recommendation-and-booking engine.

FIG. 10 shows a partial list of the flight attributes and user preferences that may be maintained by the currently disclosed flight-recommendation-and-booking engine and used for searching for best-matching flights for particular users.

FIG. 11 illustrates computation of a user preference.

FIGS. 12A-D provide examples of penalty calculations for a particular flight attribute.

FIGS. 13A-C illustrate a portion of a more detailed database schema for the database used in one implementation of the currently disclosed flight-recommendation-and-booking engine.

FIG. 14 illustrates an alternative view of certain of the data collected by the currently disclosed flight-recommendation-and-booking systems.

FIG. 15 illustrates a simplistic predictive model that can be generated based on the portion of the information collected by the currently disclosed flight-recommendation-and-booking system discussed above with reference to FIG. 9.

FIG. 16 illustrates dimensional reduction.

FIG. 17 illustrates generating individual models for each user of the currently disclosed flight-recommendation-and-booking system.

FIG. 18 shows an alternative type of predictive model for user behavior.

FIG. 19 illustrates generation of probability-density functions.

FIGS. 20A-C provide control-flow diagrams that illustrate how the currently disclosed flight-recommendation-and-booking system can provide accurate predictions of aggregate consumer behavior.

### DETAILED DESCRIPTION

The current document is directed to methods and systems that provide accurate predictions of aggregate behavior of airline customers using information stored by airline information systems and automated reservation systems. The currently disclosed methods and systems employ models of individual airline consumers' preferences and decision-making processes generated from historical data to predict the airline consumers' future travel-related selections, choices, and other behaviors, from which accurate aggregate consumer behavior can be reliably and accurately simulated.

### Overview of Computer Systems and Computer Architecture

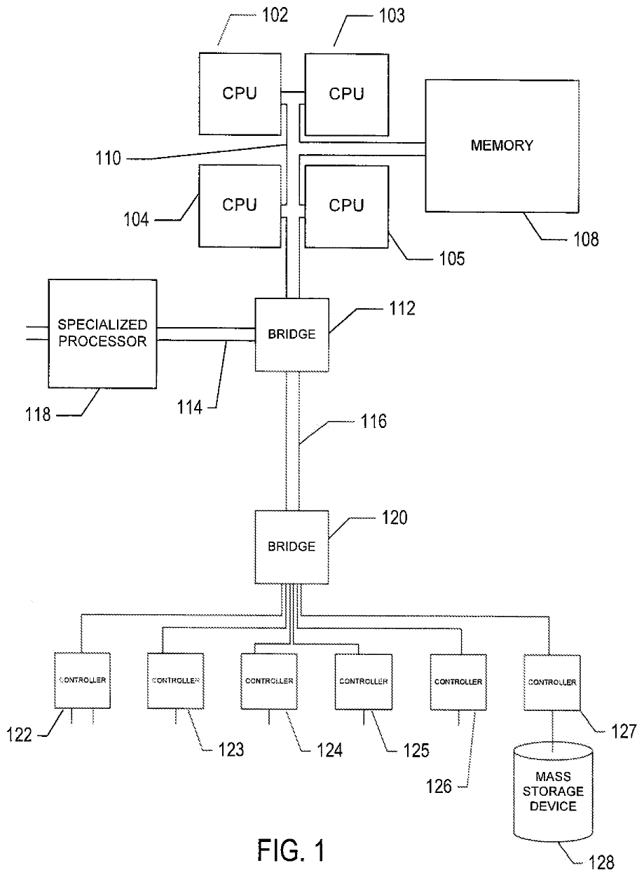

FIG. 1 provides a general architectural diagram for various types of computers. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources. It should be noted that computer-readable data-storage devices include optical and electromagnetic disks, electronic memories, and other physical data-storage devices. Those familiar with modern science and technology appreciate that electromagnetic radiation and propagating signals do not store data for subsequent retrieval, and can transiently “store” only a byte or less of information per mile, far less information than needed to encode even the simplest of routines.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of servers and workstations, and higher-end mainframe computers, but may also include a plethora of various types of special-purpose computing devices, including data-storage systems, communications routers, network nodes, tablet computers, and mobile telephones.

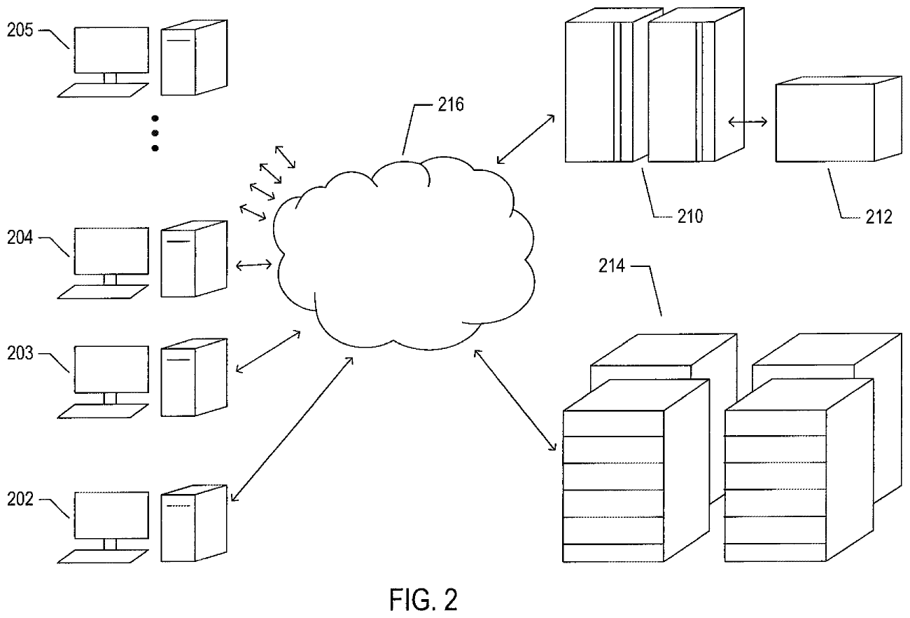

FIG. 2 illustrates an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted servers or blade servers all interconnected through various communications and networking systems that together comprise the Internet 216. Such distributed computer systems provide diverse arrays of functionalities. For example, a PC user sitting in a home office may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web servers, back-end computer systems, and data-storage systems for serving web pages to remote customers, receiving orders through the web-page interface, processing the orders, tracking completed orders, and other myriad different tasks associated with an e-commerce enterprise.

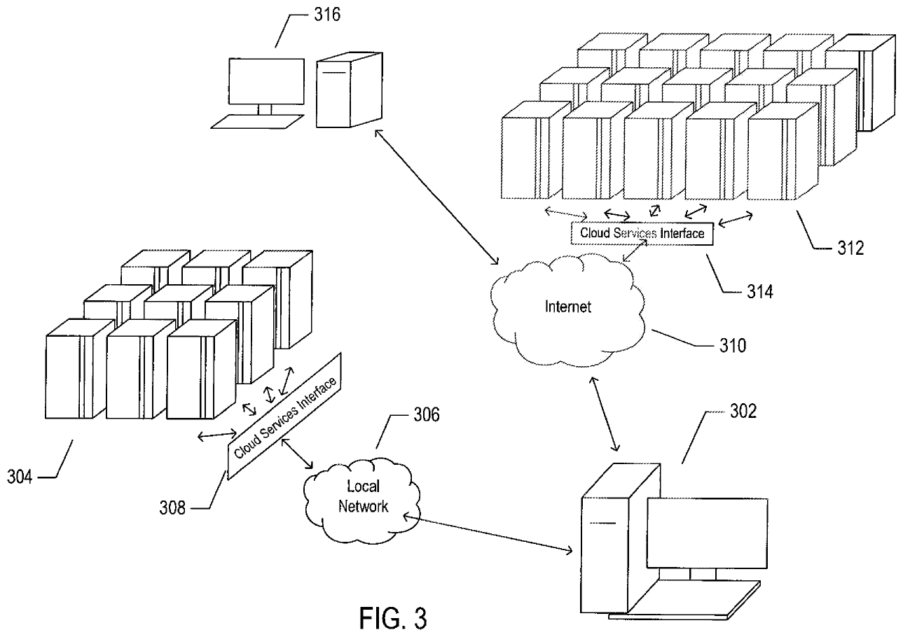

FIG. 3 illustrates cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and also accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

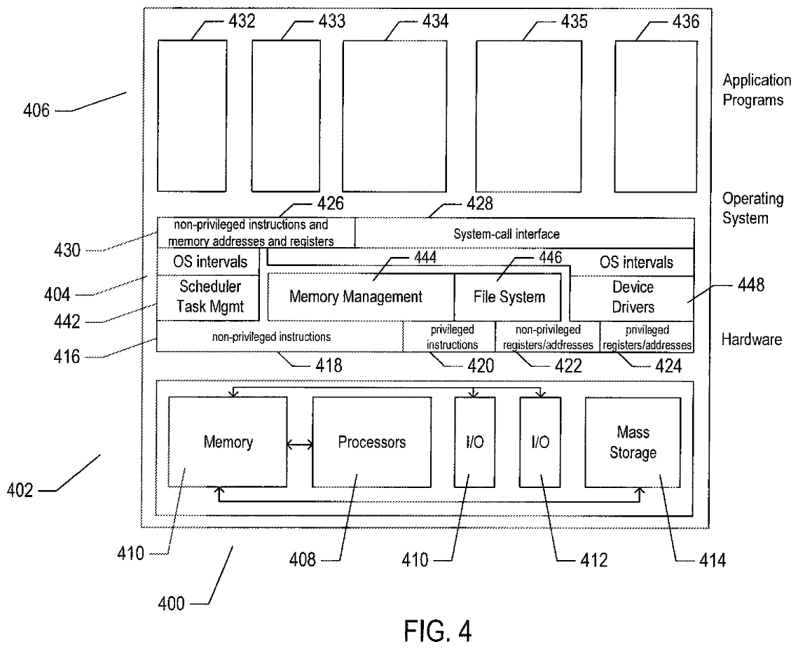

FIG. 4 illustrates generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor resources and other system resources with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory resources as a high-level, easy-to-access, file-system interface. In many modern operating systems, the operating system provides an execution environment for concurrent execution of a large number of processes, each corresponding to an executing application program, on one or a relatively small number of hardware processors by temporal multiplexing of process execution. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems, and can therefore be executed within only a subset of the various different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

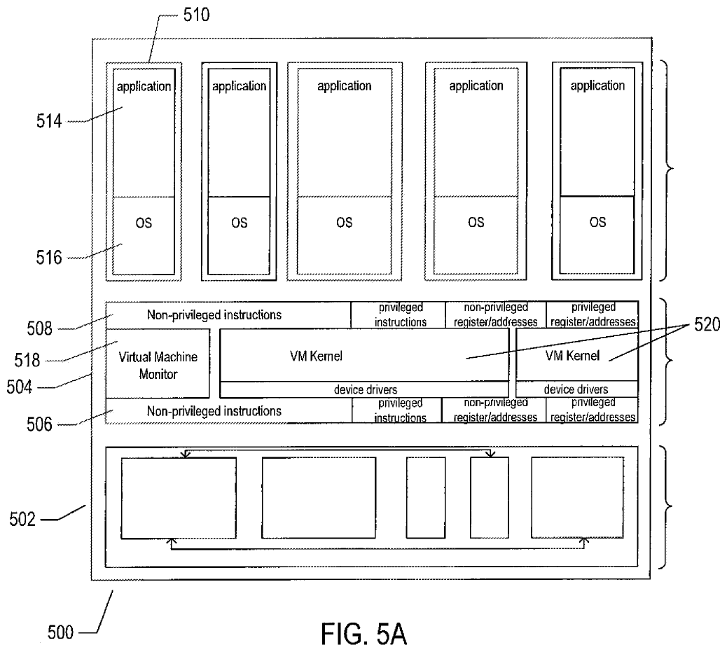

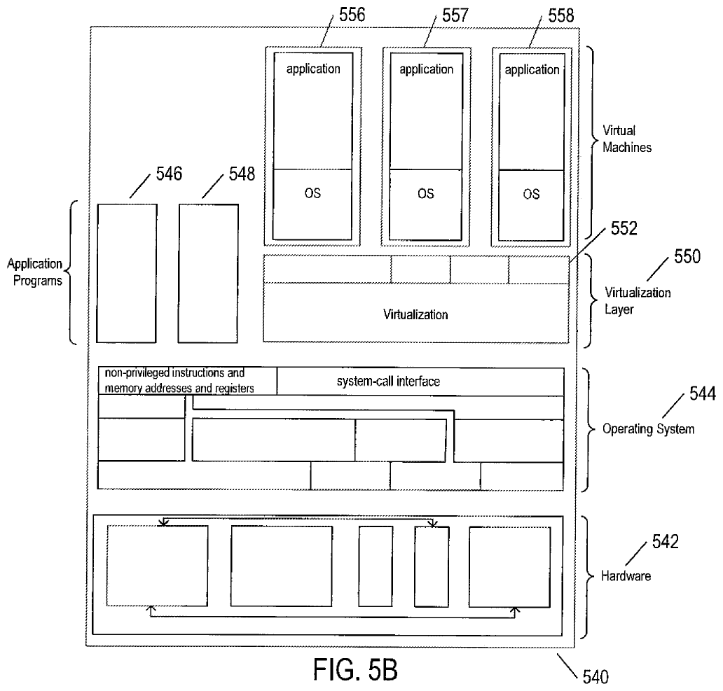

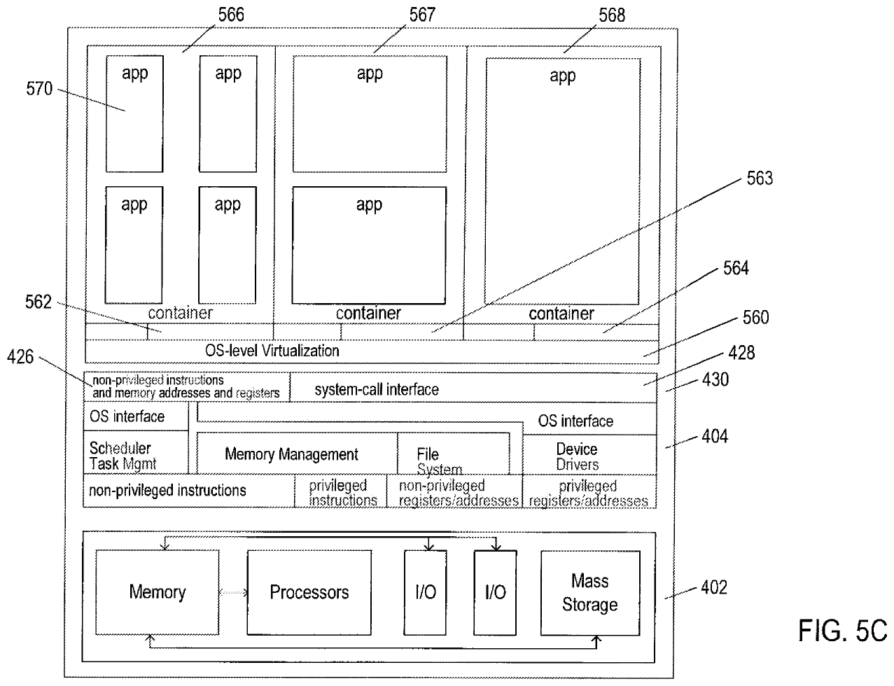

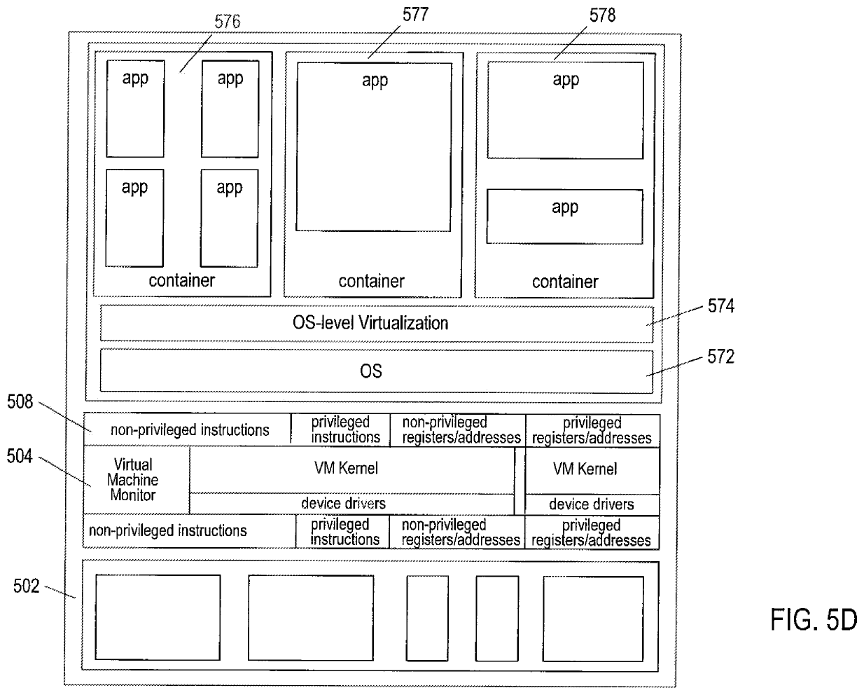

For all of these reasons, a higher level of abstraction, referred to as the “virtual machine,” has been developed and evolved to further abstract computer hardware in order to address many difficulties and challenges associated with traditional computing systems, including the compatibility issues discussed above. FIGS. 5A-D illustrate several types of virtual machine and virtual-machine execution environments. FIGS. 5A-D use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment illustrated in FIG. 5A features a virtualization layer 504 that interfaces through a virtualization-layer/hardware-layer interface 506, equivalent to interface 416 in FIG. 4, to the hardware. The virtualization layer provides a hardware-like interface 508 to a number of virtual machines, such as virtual machine 510, executing above the virtualization layer in a virtual-machine layer 512. Each virtual machine includes one or more application programs or other higher-level computational entities packaged together with an operating system, referred to as a “guest operating system,” such as application 514 and guest operating system 516 packaged together within virtual machine 510. Each virtual machine is thus equivalent to the operating-system layer 404 and application-program layer 406 in the general-purpose computer system shown in FIG. 4. Each guest operating system within a virtual machine interfaces to the virtualization-layer interface 508 rather than to the actual hardware interface 506. The virtualization layer partitions hardware resources into abstract virtual-hardware layers to which each guest operating system within a virtual machine interfaces. The guest operating systems within the virtual machines, in general, are unaware of the virtualization layer and operate as if they were directly accessing a true hardware interface. The virtualization layer ensures that each of the virtual machines currently executing within the virtual environment receive a fair allocation of underlying hardware resources and that all virtual machines receive sufficient resources to progress in execution. The virtualization-layer interface 508 may differ for different guest operating systems. For example, the virtualization layer is generally able to provide virtual hardware interfaces for a variety of different types of computer hardware. This allows, as one example, a virtual machine that includes a guest operating system designed for a particular computer architecture to run on hardware of a different architecture. The number of virtual machines need not be equal to the number of physical processors or even a multiple of the number of processors.

The virtualization layer includes a virtual-machine-monitor module 518 (“VMM”) that virtualizes physical processors in the hardware layer to create virtual processors on which each of the virtual machines executes. For execution efficiency, the virtualization layer attempts to allow virtual machines to directly execute non-privileged instructions and to directly access non-privileged registers and memory. However, when the guest operating system within a virtual machine accesses virtual privileged instructions, virtual privileged registers, and virtual privileged memory through the virtualization-layer interface 508, the accesses result in execution of virtualization-layer code to simulate or emulate the privileged resources. The virtualization layer additionally includes a kernel module 520 that manages memory, communications, and data-storage machine resources on behalf of executing virtual machines (“VM kernel”). The VM kernel, for example, maintains shadow page tables on each virtual machine so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of IO devices, including keyboards, optical-disk drives, and other such devices. The virtualization layer essentially schedules execution of virtual machines much like an operating system schedules execution of application programs, so that the virtual machines each execute within a complete and fully functional virtual hardware layer.

FIG. 5B illustrates a second type of virtualization. In FIG. 5B, the computer system 540 includes the same hardware layer 542 and software layer 544 as the hardware layer 402 shown in FIG. 4. Several application programs 546 and 548 are shown running in the execution environment provided by the operating system. In addition, a virtualization layer 550 is also provided, in computer 540, but, unlike the virtualization layer 504 discussed with reference to FIG. 5A, virtualization layer 550 is layered above the operating system 544, referred to as the “host OS,” and uses the operating system interface to access operating-system-provided functionality as well as the hardware. The virtualization layer 550 comprises primarily a VMM and a hardware-like interface 552, similar to hardware-like interface 508 in FIG. 5A. The virtualization-layer/hardware-layer interface 552, equivalent to interface 416 in FIG. 4, provides an execution environment for a number of virtual machines 556-558, each including one or more application programs or other higher-level computational entities packaged together with a guest operating system.

While the traditional virtual-machine-based virtualization layers, described with reference to FIGS. 5A-B, have enjoyed widespread adoption and use in a variety of different environments, from personal computers to enormous distributed computing systems, traditional virtualization technologies are associated with computational overheads. While these computational overheads have been steadily decreased, over the years, and often represent ten percent or less of the total computational bandwidth consumed by an application running in a virtualized environment, traditional virtualization technologies nonetheless involve computational costs in return for the power and flexibility that they provide. Another approach to virtualization is referred to as operating-system-level virtualization (“OSL virtualization”). FIG. 5C illustrates the OSL-virtualization approach. In FIG. 5C, as in previously discussed FIG. 4, an operating system 404 runs above the hardware 402 of a host computer. The operating system provides an interface for higher-level computational entities, the interface including a system-call interface 428 and exposure to the non-privileged instructions and memory addresses and registers 426 of the hardware layer 402. However, unlike in FIG. 5A, rather than applications running directly above the operating system, OSL virtualization involves an OS-level virtualization layer 560 that provides an operating-system interface 562-564 to each of one or more containers 566-568. The containers, in turn, provide an execution environment for one or more applications, such as application 570 running within the execution environment provided by container 566. The container can be thought of as a partition of the resources generally available to higher-level computational entities through the operating system interface 430. While a traditional virtualization layer can simulate the hardware interface expected by any of many different operating systems, OSL virtualization essentially provides a secure partition of the execution environment provided by a particular operating system. As one example, OSL virtualization provides a file system to each container, but the file system provided to the container is essentially a view of a partition of the general file system provided by the underlying operating system. In essence. OSL virtualization uses operating-system features, such as name space support, to isolate each container from the remaining containers so that the applications executing within the execution environment provided by a container are isolated from applications executing within the execution environments provided by all other containers. As a result, a container can be booted up much faster than a virtual machine, since the container uses operating-system-kernel features that are already available within the host computer. Furthermore, the containers share computational bandwidth, memory, network bandwidth, and other computational resources provided by the operating system, without resource overhead allocated to virtual machines and virtualization layers. Again, however, OSL virtualization does not provide many desirable features of traditional virtualization. As mentioned above, OSL virtualization does not provide a way to run different types of operating systems for different groups of containers within the same host system, nor does OSL-virtualization provide for live migration of containers between host computers, as does traditional virtualization technologies.

FIG. 5D illustrates an approach to combining the power and flexibility of traditional virtualization with the advantages of OSL virtualization. FIG. 5D shows a host computer similar to that shown in FIG. 5A, discussed above. The host computer includes a hardware layer 502 and a virtualization layer 504 that provides a simulated hardware interface 508 to an operating system 572. Unlike in FIG. 5A, the operating system interfaces to an OSL-virtualization layer 574 that provides container execution environments 576-578 to multiple application programs. Running containers above a guest operating system within a virtualized host computer provides many of the advantages of traditional virtualization and OSL virtualization. Containers can be quickly booted in order to provide additional execution environments and associated resources to new applications. The resources available to the guest operating system are efficiently partitioned among the containers provided by the OSL-virtualization layer 574. Many of the powerful and flexible features of the traditional virtualization technology can be applied to containers running above guest operating systems including live migration from one host computer to another, various types of high-availability and distributed resource sharing, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides flexible and easy scaling and a simple approach to operating-system upgrades and patches. Thus, the use of OSL virtualization above traditional virtualization, as illustrated in FIG. 5D, provides much of the advantages of both a traditional virtualization layer and the advantages of OSL virtualization. Note that, although only a single guest operating system and OSL virtualization layer as shown in FIG. 5D, a single virtualized host system can run multiple different guest operating systems within multiple virtual machines, each of which supports one or more containers.

In FIGS. 5A-D, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, operating systems, containers, and computer-instruction implemented systems that execute within execution environments provided by virtualization layers, operating systems, and containers are all physical entities that include electromechanical components and computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, operating systems, containers, and higher-level systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

### Currently Disclosed Methods and Systems

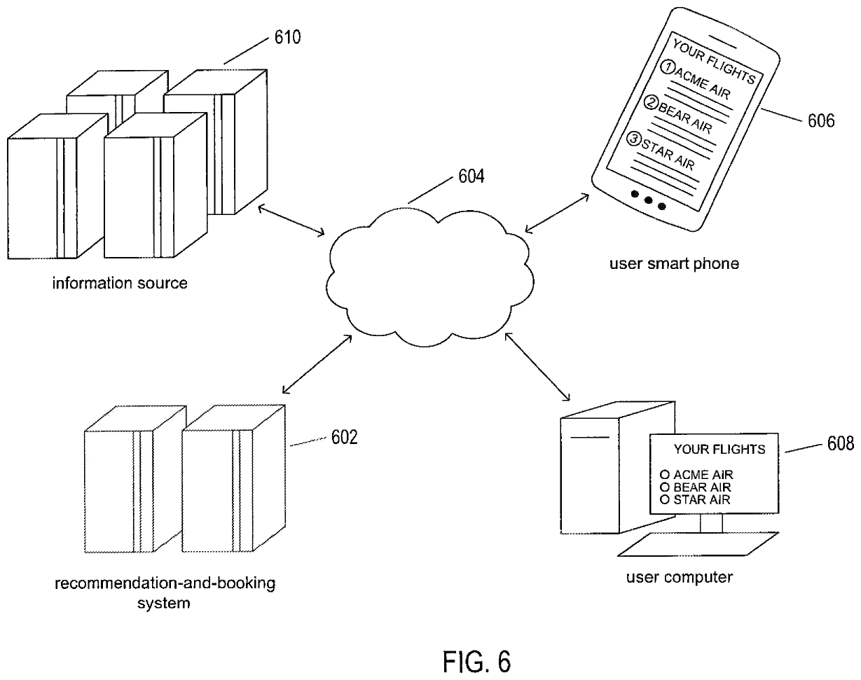

FIG. 6 illustrates the environments in which the currently disclosed methods and systems operate. The currently disclosed methods and systems are generally implemented within cloud-computing facilities, private data centers, or other types of computing environments 602 that are interconnected, via the Internet 604, with various types of user devices 606 and 608 as well as with many different types of information-providing sources 610, including airline information systems, airline-terminal information systems, automated reservation systems, and a variety of other types of systems that provide information relevant to finding suitable flights for users. Of course, the currently disclosed methods may be additionally applied to other forms of travel, including trains, steamships, and busses, and may provide searching and reservation services through a variety of endpoint devices in addition to smart phones, personal computers, tablets, and other currently well-known personal devices.

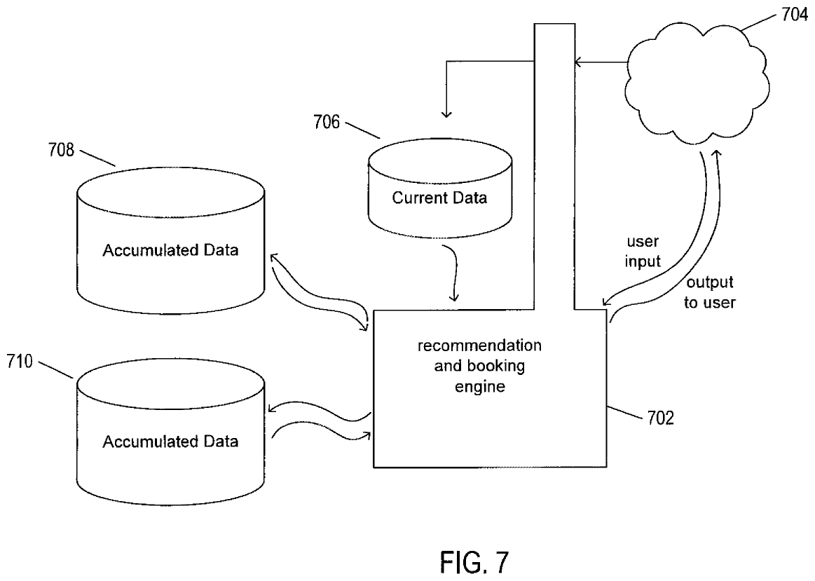

FIG. 7 illustrates the currently disclosed methods and systems at a relatively high level of abstraction. The currently disclosed systems include an automated recommendation-and-booking system that includes a recommendation-and-booking engine 702 that receives requests and transmits responses to the requests via the Internet 704, continuously monitors various information sources for relevant information, receives that information, temporarily stores the information 706, and processes the received and temporarily stored information. Information that may be needed immediately or within relatively short periods of time are cached for quick and efficient access and information that may be subsequently needed for responding to user requests is persistently stored 708 and 710, such as in various types of databases provided by various types of database-management systems. In certain implementations, the recommendation-and-booking engine 702 communicates with a client-side application that runs within user devices, for efficiency and information-security reasons. The client-side application is responsible for providing a user interface to the user and for collecting and packaging relevant information for user requests that is then transmitted to the recommendation-and-booking engine for processing. Once a user request is processed, the recommendation-and-booking engine packages response information and transmits the packaged response information to the client-side application, which then suitably renders the response information for display to the user through the user interface managed by the client-side application. The recommendation-and-booking engine and client-side applications may employ any of various different types of client-server and web-service protocols, including RESTful protocols, for communicating with one another. In other implementations, the recommendation-and-booking engine 702 responds directly to client requests issued by users' web browsers or other such generic applications, without a client-side-application intermediary. In general, the division of task execution between the recommendation-and-booking engine and a client-side application is controlled by one or more implementation parameters, with the number and nature of tasks carried out by each of the recommendation-and-booking engine and client-side applications selected to optimize multiple constraints and goals.

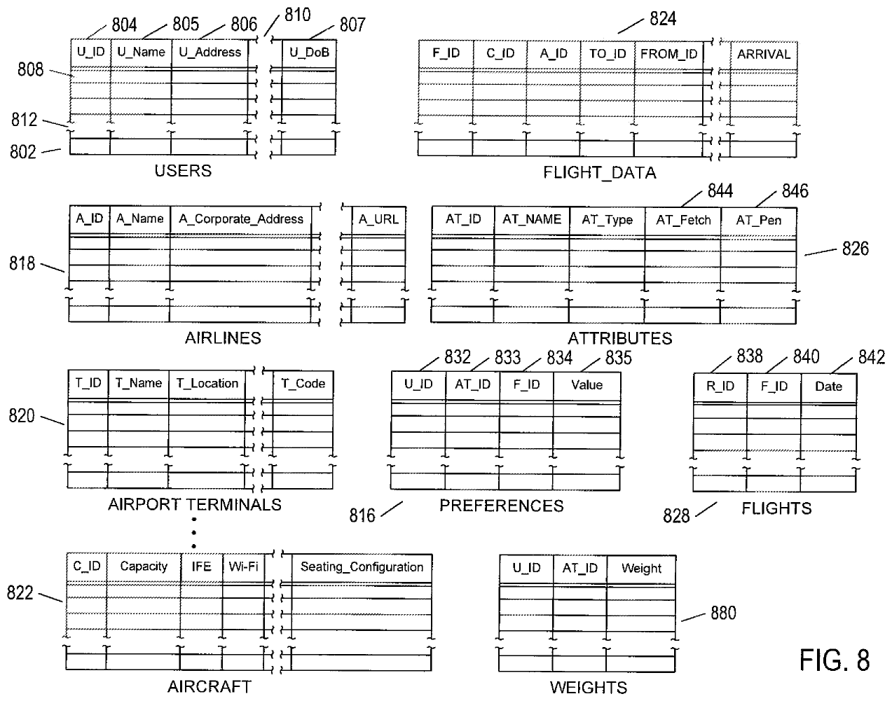

FIG. 8 illustrates an example database that can be used, by certain implementations of the currently disclosed methods and systems, for persistently storing data. The example database is a relational database and a portion of the schema for this relational database is illustrated in FIG. 8 as a set of relational-database tables. These tables, such as the USERS table 802, each include multiple columns, such as columns 804-807 in table 802, and multiple rows. Each column represents a field within a record. Each row in the table, such as the first row 808, represents a record. The data contained in the rows of the table shown in FIG. 8 are not shown. Broken columns, such as broken column 810, and broken rows, such as broken row 812, indicate the presence of additional columns and rows, respectively. Each row in the USERS table 802 represents a different user of the currently disclosed automated flight-recommendation-and-booking system. A user may be described by a numeric user identifier, corresponding to the column U_ID 804, a name, corresponding to the column U_Name 805, an address corresponding to the column U_Address, and a date of birth, corresponding to the column U_DoB 807. Broken column 810 indicates that there may be many additional columns/fields for each user, such as email address, phone number, gender, country of residence, country of passport, and other such information. In general, in the schema shown in FIG. 8, there is a unique identifier field, generally the first field in the table, for each entry in the table. In certain cases, the unique identifier for an entry is a combination of identifiers, such as for entries in the table PREFERENCES 816. Additional tables include AIRLINE 818. AIRPORT_TERMINALS 820, AIRCRAFT 822, FLIGHT_DATA 824. ATTRIBUTES 826, PREFERENCES 816, FLIGHTS 828, and WEIGHTS 830. Each entry in the table AIRLINES 818 represents a different airline. Each entry in the table AIRPORT_TERMINALS 820 represents a different airport. Each entry in the table AIRCRAFT 822 represents a different type of airplane. Each entry in the table FLIGHT_DATA 824 represents a different route or flight regularly offered by an airline. Each entry in the table ATTRIBUTES 826 represents a different attribute. These attributes provide the basis for searching for flights that best match a user's preferences and flight parameters. Each entry in the table PREFERENCES 816 represents a different user preference. The identifier, or key, for each preference is a combination of a user identifier 832, an attribute identifier 833, and a flight/route identifier 834. Thus, entries in one table may refer to entries in other tables via numeric identifiers, or keys. For simplicity, the value for each preference 835 is a character string, which may be converted into numeric values, time-of-day values, date values, and other types of values appropriate for a particular attribute or for computation of a particular penalty. Each entry in the table FLIGHTS 828 represents a different specific flight. A specific flight is associated with a specific-flight identifier 838 and is described by a flight/route identifier 840 and a date 842. Each entry in the table WEIGHTS 830 represents a weighting factor that is applied to penalties computed from attribute/preference values in order to generate an overall penalty for each flight that meets the parameters specified by a user, as further discussed below. Specific flights with the lowest penalties are chosen for initial display to a user. The data in certain fields may constitute a reference to a stored procedure or routine. For example, in the table ATTRIBUTES, column 844 stores references to stored procedures or routines that are called to fetch and/or compute the attribute value and column 846 stores references to stored procedures or routines that are called to compute a penalty for a particular user and a particular flight for the particular attribute.

There are, of course, many different possible relational-database schemas that may be used to store data by the currently disclosed methods and systems as well as many different non-relational-database storage systems that may be alternatively employed. In addition, the recommendation-and-booking engine generally monitors the stored data to remove or archive no-longer-needed data. The above schema is a simple example. Most implementations would store additional information. For example, rather than recommending flights, the recommendation system may be viewed as recommending tickets, since a given flight may include seats with different pricings and services, and thus additional information about flights would need to be stored and managed.

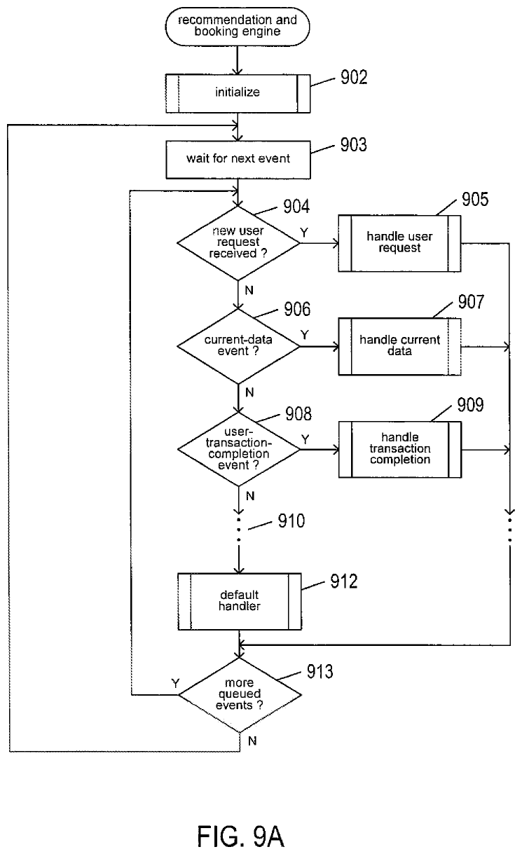

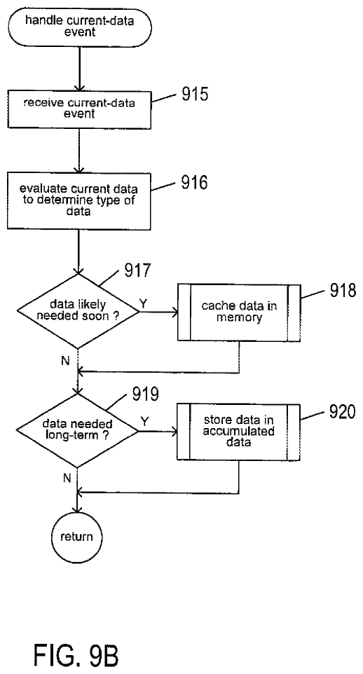

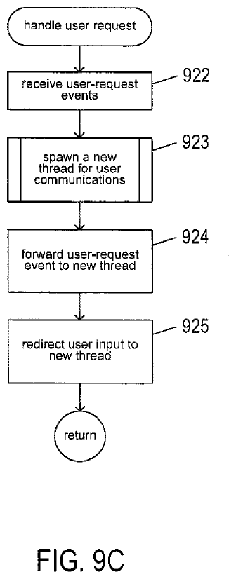

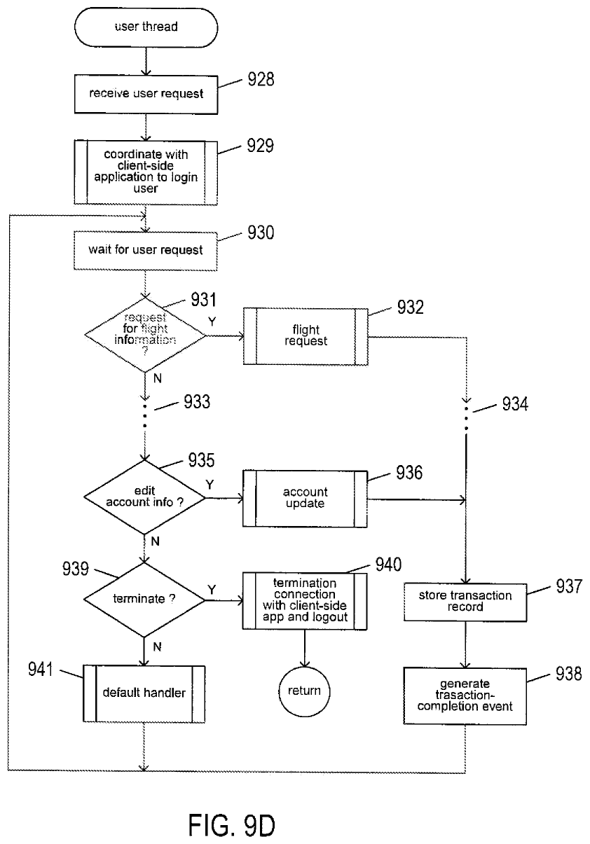

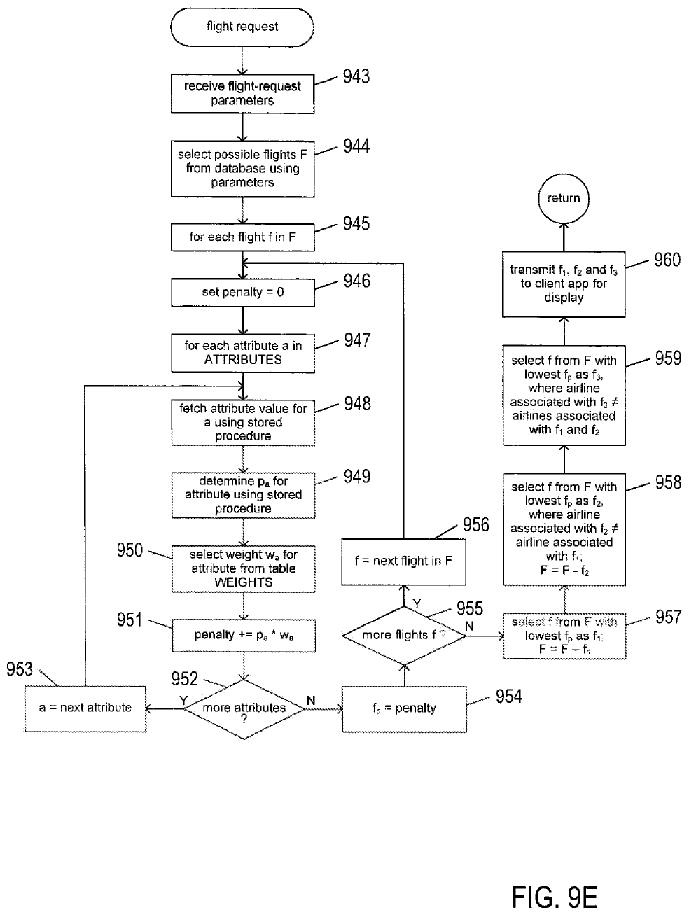

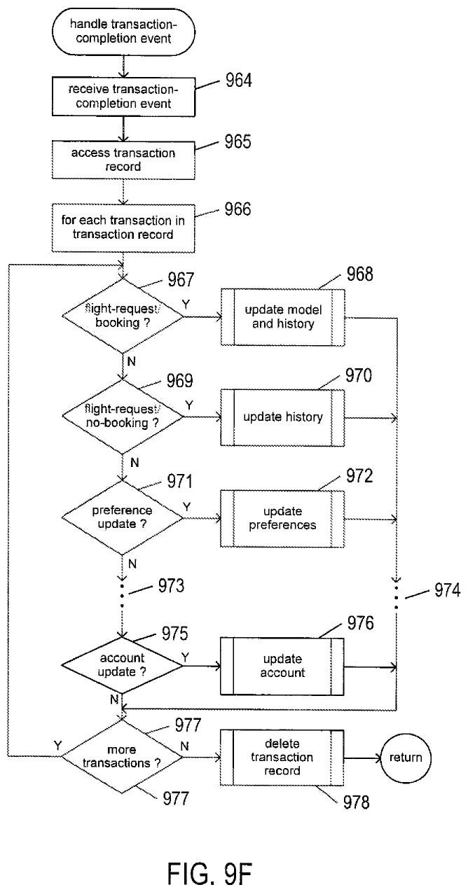

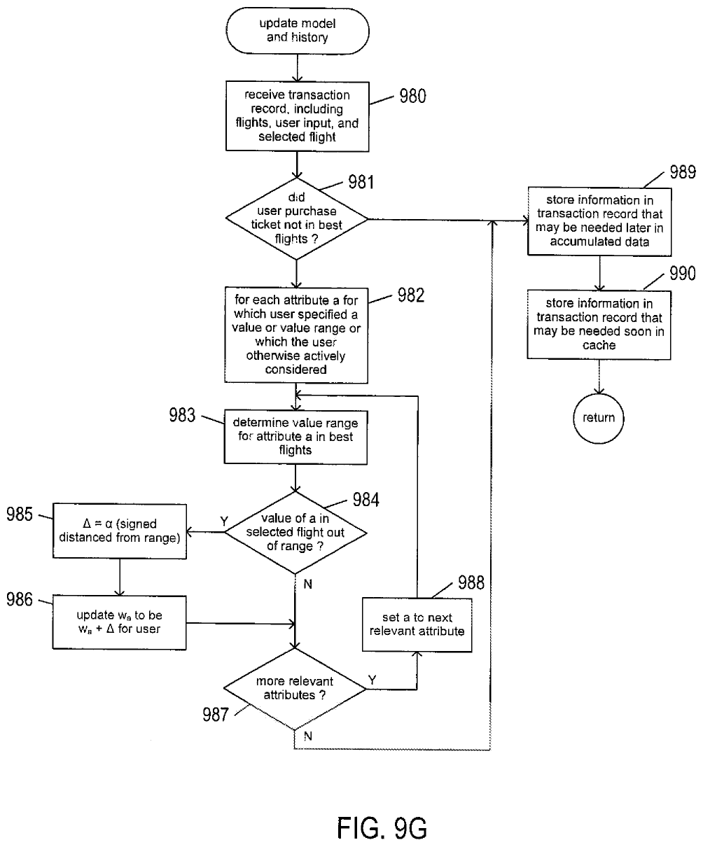

FIGS. 9A-G provide control-flow diagrams to illustrate certain aspects of one implementation of the currently disclosed recommendation-and-booking engine. FIG. 9A provides a control-flow diagram that illustrates the general event-loop architecture of this implementation. In step 902, invoked when the flight-recommendation-and-booking engine is powered up, an initialization routine is called to initialize the recommendation-and-booking engine. This may involve launching a database-management system, initializing in-memory data structures, initializing and verifying communications subsystems, and many other such initialization tasks. In step 903, the flight-recommendation-and-booking engine waits for a next event to occur. When the next occurring event is reception of a new user request, as determined in step 904, a user-request handler is called, in step 905. When the next-occurring event is a current-data event, as determined in step 906, a current-data handler is called, in step 907. When the next occurring event is a user-transaction-completion event, as determined in step 908, then a transaction-completion handler is called, in step 909. Ellipses 910 indicate that many other types of events may be received and handled by the flight-recommendation-and-booking engine. Finally, a default handler 912 is called to handle any rare or unexpected events. Following handling of the next occurring event, when there are more events to handle that have been queued during handling of previous events, as determined in step 913, control returns to step 904. Otherwise, control returns to step 903, where the flight-recommendation-and-booking engine waits for a next event to occur.

FIG. 9B provides a control-flow diagram for the current-data handler, called in step 907 of FIG. 9A. In step 915, the current-data handler receives a current-data event. The event is associated with a reference to data that has been received via the information-source monitoring functionality of the flight-recommendation-and-booking engine. In step 916, the current-data handler evaluates the received data to characterize the storage requirements for the data. When the data is likely to be needed immediately or within a relatively short period of time, as determined in step 917, the data is cached in memory or in a quickly accessible mass-storage device, in step 918. When the data is likely to be subsequently needed, long term, for searching for flights or for other purposes, as determined in step 919, the data is stored in the accumulated data, such as in a database, in step 920.

FIG. 9C provides a control-flow diagram for user-request handler, called in step 905 of FIG. 9A. In step 922, the user-request handler receives the user-request event. As discussed above, a user-request is packaged and formatted by the client-side application, and in the currently described implementation, includes a request type, a return communications address, and other such information. In step 923, the user-request handler creates a new thread to handle the user request and any subsequent requests made by the user within the context of a communications connection. In step 924, the user-request handler forwards the user-request event to the new thread for processing. In step 925, the user-request handler redirects subsequent user input to the new thread. Thus, in the currently described implementation, upon receiving an initial request from a user, a new thread is created to manage communications with the user via the client-side application running within the user's device and to process received requests.

FIG. 9D provides a control-flow diagram for a user thread created in step 923 of FIG. 9C. In step 928, the user thread receives the user request forwarded to the user thread by the user-request handler, in step 924. In step 929, the user thread coordinates with the user's client-side application to login the user and respond to the initial request received from the user. Then, in step 930, the user thread waits for additional user requests. When the next user request is a request for flight information, as determined in step 931, a flight-request handler is called, in step 932. Ellipses 933 and 934 indicate that many additional different types of user requests may be handled by the user thread. When the next user request is a request to edit account information, as determined in step 935, an account-update handler is called, in step 936. Following completion of each of the different types of handlers for handling the different types of user requests, the user thread stores a transaction record, in step 937, and generates a transaction-completion event, in step 938. When the next received request is a request to terminate the connection, as determined in step 939, the user thread terminates the communications connection with the client-side application, logs out the user, and terminates, in step 940. A default handler 941 handles any unusual and rare events.

FIG. 9E provides a control-flow diagram for the flight-request handler, called in step 932 of FIG. 9D. In Step 943, the flight-request handler receives the flight-request parameters included in the request for flight information. In step 944, the flight-request handler searches the database for the set of flights F that satisfy the flight parameters. In the outer for-loop of steps 945-956, the flight-request handler considers each flight ƒ in the set of flights F and generates a penalty for each flight ƒ. In step 946, the local variable penalty is set to 0. Then, in the inner for-loop of steps 947-953, the value for each attribute a for the currently considered flight ƒ is obtained and used to determine a penalty for the attribute, which is then added to the overall penalty stored in the local variable penalty. In step 948, the value of the attribute a is fetched using the stored procedure or routine referenced from the column AT_Fetch in the ATTRIBUTES table (844 in FIG. 8). The attribute value may be selected from a field of a table entry corresponding to a single column or may be computed from the values in multiple fields of one or more table entries. In step 949, a penalty is computed for the attribute using the stored procedure or routine referenced from a field corresponding to the column AT_Pen in the ATTRIBUTES table (846 in FIG. 8). In step 950, a user-specific weight for the attribute is selected from the table WEIGHTS (830 in FIG. 8). Then, in step 951, the penalty for the attribute, the product of the selected weight and the computed attribute penalty, is added to the contents of the local variable penalty. When there are more attributes to consider for the currently considered flight ƒ as determined in step 952, the next attribute a is obtained in preparation for a next iteration of the inner for-loop of steps 947-953. Otherwise, in step 954, the contents of the local variable penalty is stored as the penalty for the currently considered flight ƒ When there are more possible flights to consider, as determined in step 955, the next possible flight ƒ is selected from the set of possible flights F, in step 956, and control returns to step 946 to undertake a next iteration of the outer for-loop of steps 945-956. In the currently disclosed implementation, the three best matching flights are selected and returned to a user in response to a request for flight information. In alternative implementations, the number of best matching flights returned is another small number, where the phrase “small number” refers to an integer in the range [1,9]. In certain implementations, the number of best matching flights returned is a parameter that may be specific to individual users, to classes of users, and/or to user display devices. In other implementations, the number of best matching flights is a small number specified by a system parameter. This system parameter may be, in part, derived from the display capabilities of the user's display device. In step 957, the first of these three flights is obtained by selecting the flight from the set of flights F with the lowest associated penalty. The selected flight is then removed from the set F. Then, in step 958, the second flight is obtained by again selecting the flight from F with the lowest associated penalty and that is offered by an airline different from the airline that offers the first selected flight. The second flight is removed from the set F. In step 959, the third flight is selected by again selecting the flight from F with the lowest associated penalty and that is offered by an airline different from the airlines that offer the first and second selected flights. Finally, in step 960, information for the three selected flights is packaged into a response message that is transmitted to the client-side application on the user's device.

FIG. 9F provides a control-flow diagram for the transaction-completion-event handler, called in step 909 of FIG. 9A. In step 964, the transaction-completion-event handler receives the transaction-completion event. In step 965, the transaction-completion-event handler accesses the transaction record stored in step 937 of FIG. 9D. In the for-loop of steps 966-975, the transaction-completion-event handler handles each transaction contained in the transaction record. When the currently considered transaction is a flight-request/booking transaction, as determined in step 967, an update-model-and-history routine is called, in step 968. When the currently considered transaction is a flight-request transaction that did not result in a booking, an update-history routine is called, in step (70. When the currently considered transaction is a preference-update transaction, as determined in step 971, an update-preferences routine is called, in step 972. Ellipses 973-974 indicate that additional types of transactions may be handled. When the currently considered transaction is an account-update transaction, an update-account routine is called, in step 976. Once all of the transactions in the transaction record have been handled by the transaction-completion-event handler, the transaction record is deleted, in step 978.

FIG. 9G provides a control-flow diagram for the update-model-and-history routine, called in step 968 of FIG. 9F. In step 980, the update-model-and-history routine receives the transaction record for the completed flight-request/booking request, which includes a list of the best flights offered to the user, various user input, including flight-selection parameters, and an indication of the selected flight. In step 981, the update-model-and-history routine determines whether the user selected, for booking, a flight that was not recommended to the user. If so, then in the for-loop of steps 982-988, the update-model-and-history routine considers each attribute a of the selected flight for which the user-specified a value or value range or which the user otherwise considered, such as by applying filters with respect to the attribute. In step 983, the update-model-and-history routine determines a value range for the currently considered attribute a with respect to the recommended flights. When the value for the currently considered attribute a is outside of this value range, as determined in step 984, then, in step 985, the update-model-and-history routine determines a value for a local variable Δ as the product of a value a and the signed distance of the value of the currently considered attribute a from the closest extreme value of the determined value range. The value a is the learning rate. In certain implementations, the value a may vary, over time, with respect to different user, and/or with respect to a computed stability or rate of change for the user's preferences. In step 986, the weight associated with the currently considered attribute a and the user is updated by adding the contents of the local variable Δ to the current weight associated with the currently considered attribute a. When there are more relevant attributes to consider in the for-loop of steps 982-988, the update-model-and-history routine then stores various information from the transaction record into one or more of the persistently stored accumulated data and the cache in step 989-990.

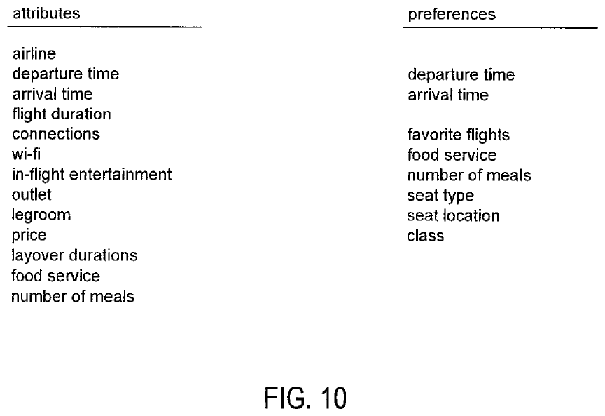

FIG. 10 shows a partial list of the flight attributes and user preferences that may be maintained by the currently disclosed flight-recommendation-and-booking engine and used for searching for best-matching flights for particular users. Particular implementations may use a greater number or fewer attributes and/or preferences, may consider additional attributes and preferences, and may not consider certain of the attributes and preferences shown in FIG. 10. Flight attributes include the airline, departure and arrival times, the duration of the flight, the number of connections and information about the connections, whether or not electric-power outlets, wireless communications, and in-flight entertainment are available to passengers on the flight, an indication of the amount of legroom available to passengers, the price of the flight, the availability of food service and the number of meals served, and other such information. Of course, the values of these attributes may be interdependent. For example, the availability of wireless communications, electric-power outlets, meals, and in-flight entertainment may depend on the class of ticket, as does the amount of legroom and perhaps other attribute values. Additional attributes may be related to available seat positions, type of aircraft, average amount of flight delays and flight cancellations associated with the airline and with the flight in particular, the country in which the airline is based, additional services provided by the airline both in-flight and from the ground, ground-transportation options available to passengers on the flight, and many other such attributes. User preferences may include preferences with respect to the departure and arrival times, a list of indications of favorite flights, the availability and type of food service, ticket class, see location, aircraft type, and a variety of additional preferences that may mirror the flight attributes maintained for flights by the flight-recommendation-and-booking system or that can be determined based on those attributes.

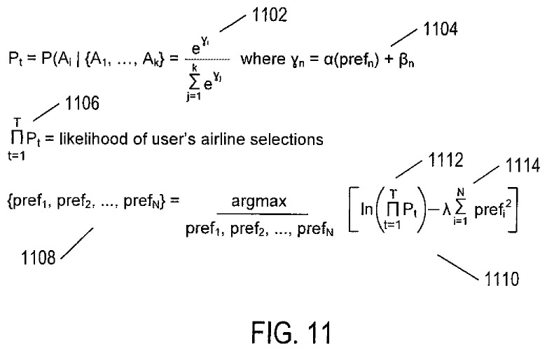

FIG. 11 illustrates computation of a user preference. In general, user preferences may be specified by users, through a user-preference-specification facility within the user interface provided by the client-side application, and/or may be calculated by the recommendation-and-booking system based on the user-transaction history, user preferences stored for a user, and/or other information. As one example, FIG. 11 illustrates computation of airline preferences for a user based on the user's travel history. The probability Pₜ that a user traveled on a particular route with a particular airline Aᵢ during a trip t, given that the route was offered by K different airlines that included airline Aᵢ, is estimated by the expression 1102, where the symbol γₙ is the sum 1104 of a constant α times the user's preference for airline Aₙ, prefₙ, and a constant βₙ related to the overall popularity of airline Aₙ. The product of the probabilities that the user traveled on particular airlines over the course of T trips 1106 is related to the likelihood of the history of user airline selections. A set of airline preferences 1108 for the user can then be obtained by choosing values for the preferences that maximize expression 1110, which includes a first term 1112 related to the likelihood of the user's airline selections and a second term 1114 that attempts to constraint the magnitudes of the preferences. This, of course, is just one example of the many different types of ways in which user preferences may be computed by the automated recommendation-and-booking system.

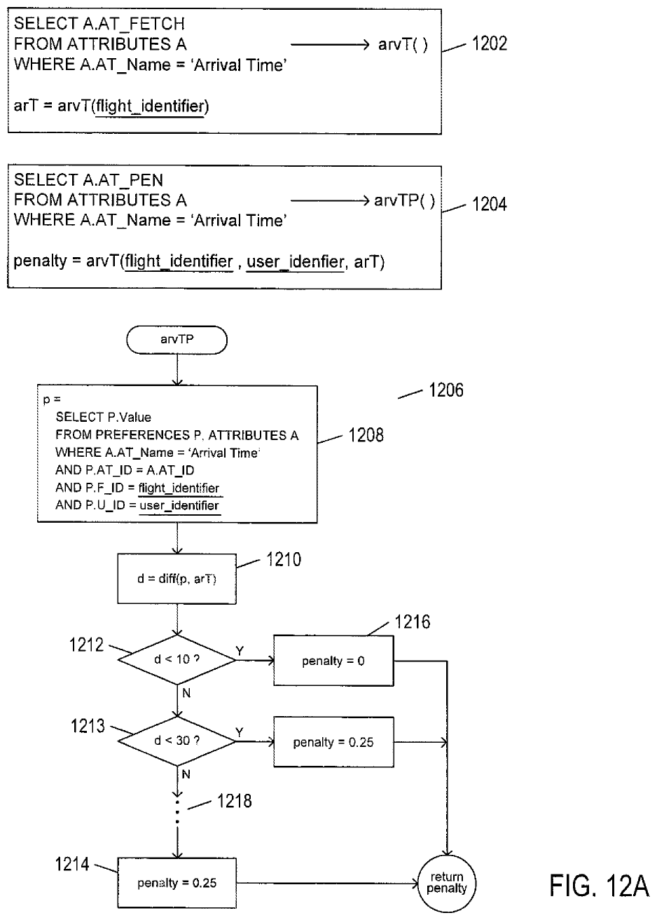

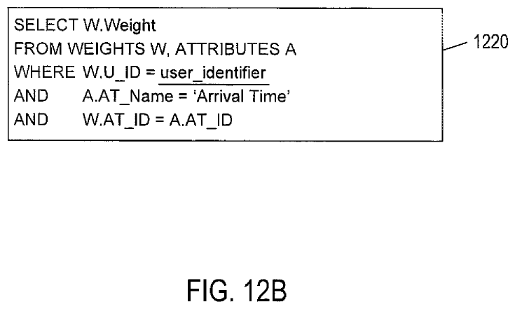

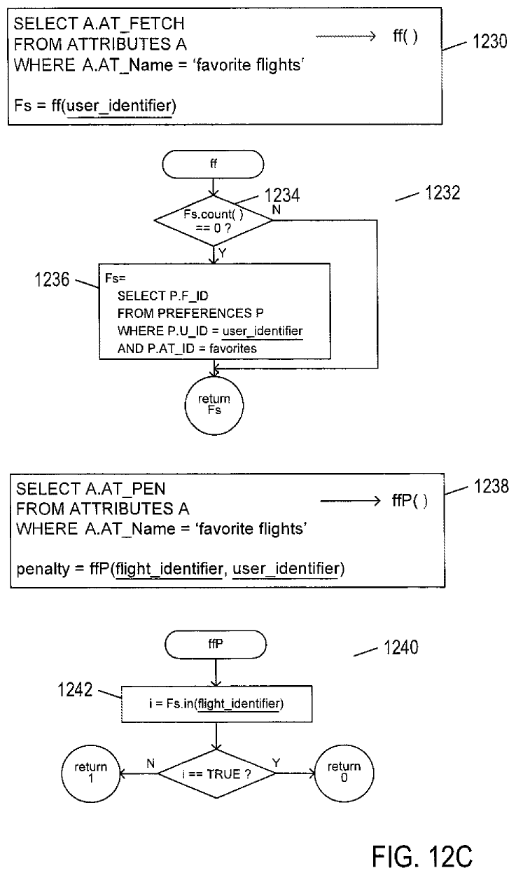

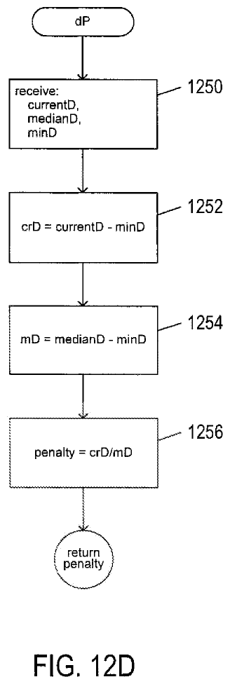

FIGS. 12A-D provide examples of penalty calculations for a particular flight attribute. FIGS. 12A-B show calculation, for a particular user and flight, of a penalty for the arrival-time attribute. Assuming the relational-database schema shown in FIG. 8, the structured query language (“SQL”) command and following routine call, in step 1202, retrieves a reference to a routine arvT that is a stored procedure referenced by the field AT_Fetch in an entry in the table ATTRIBUTES for the Arrival Time attribute. The routine arvT( ) is passed the identifier for a flight, stored in a local variable flight_identifier, when executed to obtain the arrival time for the flight to store the arrival time in a local variable arT. Step 1202 corresponds to a specific implementation of step 948 in FIG. 9E. Step 1204 is a specific implementation of step 949 in FIG. 9E. The SQL command in this step fetches a reference to a penalty-computing stored procedure, arvTP( ), and this routine, supplied with arguments that include a flight identifier and a user identifier stored in a local variables flight_identifier and user_identifier, is then executed to compute the penalty for the Arrival Time attribute. A control-flow diagram 1206 is provided, in a lower portion of FIG. 12A, for the routine arvTP( ). In step 1208, an SQL command is executed in order to obtain the contents of the field Value, which is stored in local variable p, for the entry in the PREFERENCES table for the user identified by user_identifier, the flight identified by flight_identifier, and the Arrival Time attribute. In step 1210, local variable d is set to the difference, in minutes, between the preferred arrival time p and the arrival time for the flight obtained by the call to the stored procedure arvT, in step 1202. This difference is computed by the function diff( ). The maximum possible time difference is 720 minutes. Then, in a series of conditional steps 1212-1214, the computed difference is compared to various constant values. When, in each step, the difference is less than the constant value, a penalty is then calculated. For example, when the computed differences less than 10 minutes, determined in step 1212, the penalty is set to 0, in step 1216. Ellipsis 1218 indicates that there may be additional conditional steps. Finally, the SQL command in step 1220 of FIG. 12B implements step 950 in FIG. 9E. Thus, FIGS. 12A-B provide one example of a specific penalty computation that is more generally illustrated as steps at 948-951 in FIG. 9E. This illustration does not consider various types of errors that may occur, for the sake of simplicity of illustration. For example, it may be the case that a user has not specified a preference for the arrival time for a particular flight, but has instead only specified a preference for the arrival time for flights in general. In this case, the table PREFERENCES may contain an entry in which the F_ID field contains a value representing all flights, rather than an identifier for a particular flight, and the arrival time in that entry would be used to calculate the penalty. In alternative implementations, even the penalty calculation may be tailored to specific users or classes of users, with the stored procedure arvTP using additional database information to select a specific penalty calculation for a particular user or for a class of users to which a particular user belongs.

FIG. 12C illustrates another specific penalty computation for the favorite flights attribute. Step 1230 is a specific implementation of step 948 FIG. 9E. The SQL command is executed to fetch a reference to the stored procedure ƒƒ( ), which is then executed with an argument identifying the user to return a list of flight identifiers, Fs, representing the favorite flights for the user. A control-flow diagram 1232 is provided for the routine ƒƒ( ). When the list Fs contains no entries, as determined in step 1234, an SQL command is executed, in step 1236, to obtain the flight identifiers for all of the flights that have been indicated by the user to be favorite flights. These favorite-flight indications are stored in entries in the table PREFERENCES with the field AT_ID containing a value favorites that is not an identifier of an entry in the ATTRIBUTES table. Step 1238 represents a specific implementation of step 949 in FIG. 9E. A reference to the stored penalty routine ffP( ) for the favorite flights attribute is obtained by execution of the SQL command and the obtained routine is then executed to return the penalty. A control-flow diagram 1240 for the routine ffP( ) is provided in the lower portion of FIG. 12C. In step 1242, the local variable i is set to a Boolean value indicating whether or not the identifier for a particular flight, flight_identifier, is stored in the list Fs. If so, a penalty of 0 is returned and, otherwise, a penalty of 1 is returned.

FIG. 12D provides a control-flow diagram that illustrates computation of a penalty for a flight-duration attribute. In step 1250, the routine dP receives the duration of a current flight, currentD, the median duration for all flights between same two cities connected by the current flight, medianD, and a minimum duration for all of the flights between the same two cities, minD. These received values can be directly retrieved from, or computed by multiple values retrieved from, the database. In step 1252, the relative duration for the current flight, crD, is computed as the difference between currentD and minD. In step 1254, the median relative duration, mD, is computed as the difference between medianD and minD. Finally, in step 1256, the penalty is computed as the ratio of crD to mD.

The example penalty calculation shown in FIGS. 12A-D are merely examples of how penalty calculations are computed from information stored in the database. The penalty for each different attribute may be differently calculated and, as mentioned above, it is even possible that the penalty calculations may differ among specific users and/or classes of users. There are may be many different alternative ways to compute any particular penalty for any particular attribute.

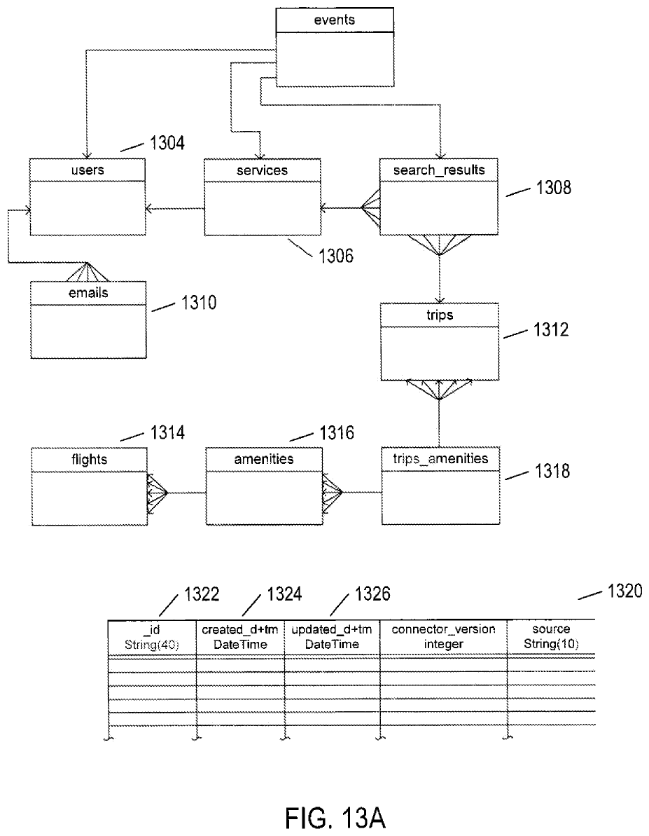

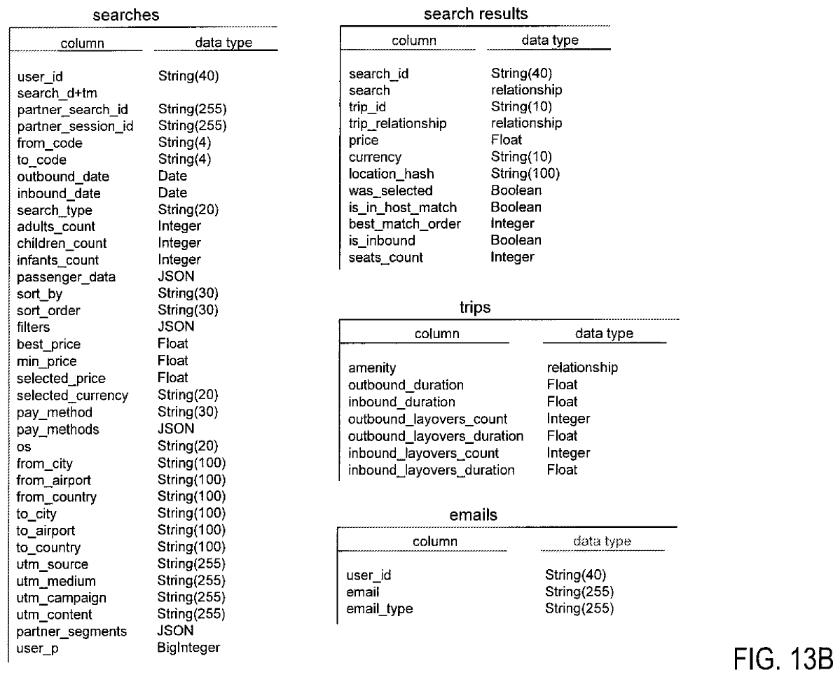

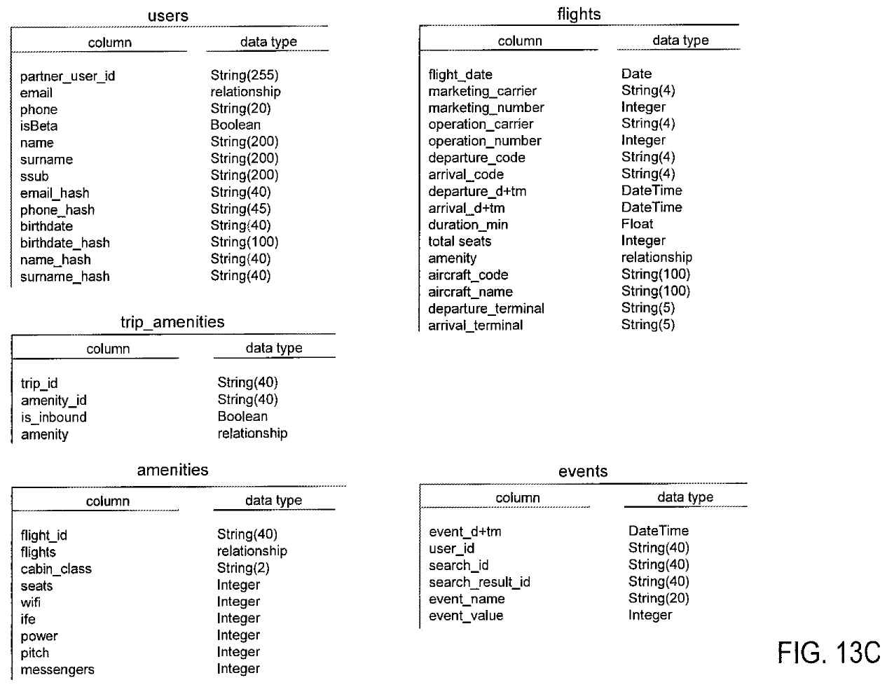

FIGS. 13A-C illustrate a portion of a more detailed database schema for the database used in one implementation of the currently disclosed flight-recommendation-and-booking engine. This portion of the database, as shown in FIG. 13A, includes the tables: (1) events 1302; (2) users 1304; (3) searches 1306: (4) search results 1308; (5) emails 1310; (6) traps 1312; (7), flights 1314; (8) amenities 1316: and (9) trips, amenities 1318. The portion of the database shown in FIG. 13A allows search results returned to users to be recorded in the database, so that this information can be employed to determine users' preference, system-access behaviors, whether or not users are effectively using the system and obtaining useful results, and many other types of recorded and inferred information. As one example, the above-discussed user preferences may be alternatively obtained by direct user input, by analyzing stored information, such as information about users' searches and the search results returned to users, or by a combination of direct user input and analysis of stored information. The table events 1302 stores indications of various user-initiated events, such as search requests. The table searches 1306 stores information about each search request. The table search, results 1308 stores information about the results returned to a user in response to a search request. The table emails 1310 stores information about users' emails. Each potential trip, returned as a result to a user in response to a user's search request, is stored in the table trips 1312. The table flights 1314 stores information about particular flights. The table amenities 1316 stores characteristics of each service class for each flight. The table trips amenities 1318 provides relationships between trips and characteristics of each class of service for each flight included in the trips. As shown in the lower portion of FIG. 13A, each of the tables shown in FIG. 13A, with the exception of the table trips amenities, generally includes a common set of 5 columns 1320, including an identifier 1322, a creation time 1324, a most recent update time 1326, and other common information. FIGS. 13B-C provides indications of the remaining fields, and the data types of the remaining fields, in each of the tables.

The currently disclosed flight-recommendation-and-booking systems store a great amount of data about individual users' choices, selections, preferences, and travel behaviors. This information can be used to generate models for each of a large set of users, and these models can then be used to simulate market behavior exhibited by a population of consumers and to estimate and predict generalized, collective behaviors of consumers with respect to prospective scenarios. Such simulations provide predictive information with regard to hypothetical future market scenarios and corresponding probable consumer behaviors. In the following discussion, a simplified example related to predicting the market acceptance of a new flight or route is considered, but this is but one of many possible types of modeling and prediction that can be carried out by the currently disclosed flight-recommendation-and-booking systems.

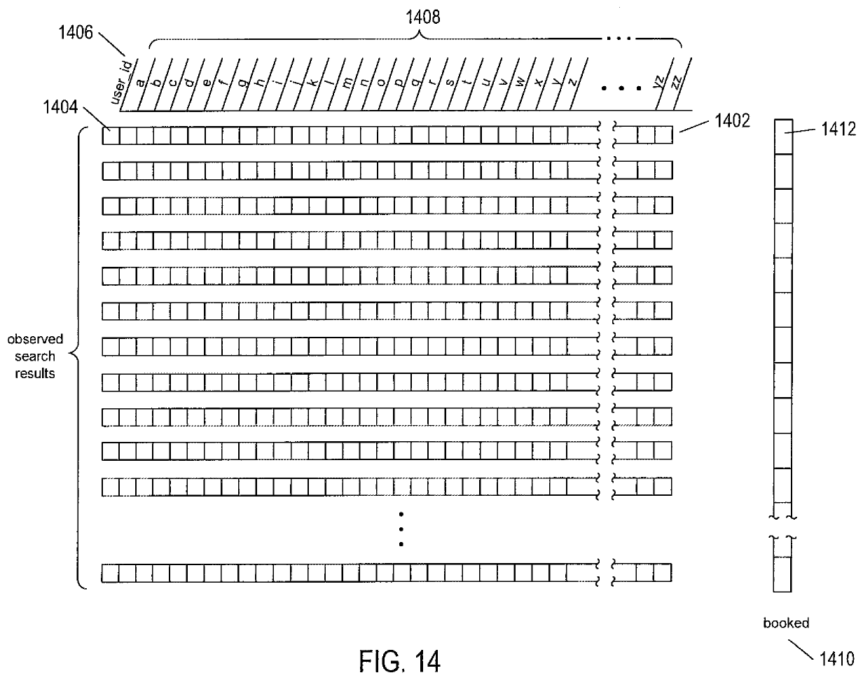

FIG. 14 illustrates an alternative view of certain of the data collected by the currently disclosed flight-recommendation-and-booking systems. In this illustration, each flight returned as a search result to a user of the system is represented as a row vector, such as row vector 1402. Each element in the row vector corresponds to the value of a different attribute associated with the search result. For example, element 1404 includes a user ID, as indicated by the label “user_id” 1406. The remaining attributes are labeled with single or double lower-case letters 1408 to represent different attributes. Many of these were discussed above and are stored in the above-discussed relational database tables. Each row vector representing a search result has the same form as the first row vector 1402. The values for the various attributes may be floating-point numbers, integers, character strings, Boolean values, and other such common data types. A separate column vector 1410, referred to as “booked,” includes an element for each row vector that represents a search result. For example, element 1412 corresponds to the first row vector 1402. Each element in the column vector “booked” can be thought of as a real number in the range [0, 1] representing the probability that the flight returned as a search result, represented by the corresponding row vector, was subsequently booked by the user. For historical data, only the Boolean values 0 and 1 occur in the column vector “booked.”

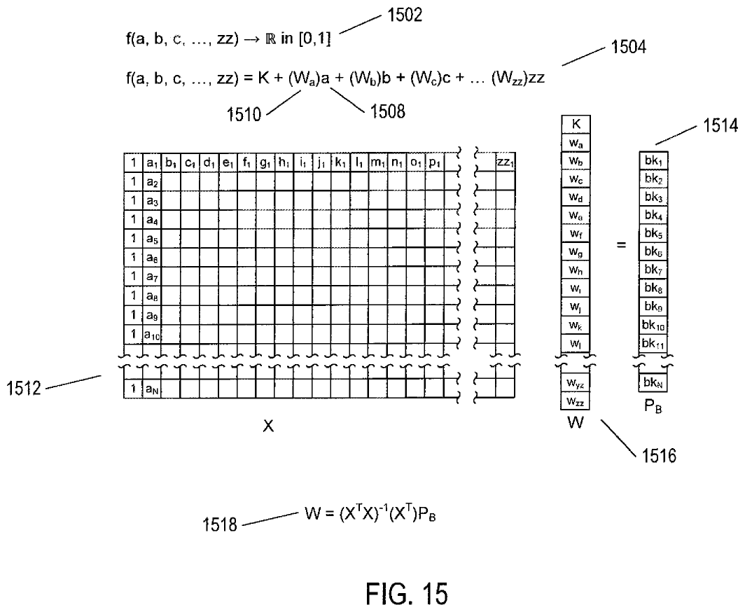

FIG. 15 illustrates a simplistic predictive model that can be generated based on the portion of the information collected by the currently disclosed flight-recommendation-and-booking system discussed above with reference to FIG. 14. The model is a linear function of the attributes of the search results other than the user_id attribute. As indicated by expression 1502, the model is a function ƒ that takes, as arguments, particular values for each of the attributes and returns a probability value in the range [0, 1]. This is the estimated probability that the flight would be booked by a generalized user. In the current example, the model function 1504 returns the weighted sum of a constant 1506 and the attribute values, such as attribute value a 1508, each multiplied by a signed weight, such as the weight w 1510 that multiplies attribute a. Of course, there are many additional types of function models that may be alternatively used. In many cases, a much more complex model is needed to reflect non-linearities and interdependencies among attributes. The current example is, as mentioned above, simplistic and not necessarily practical for any given set of attributes. The set of observations, or stored data, can be thought of as a two-dimensional matrix X 1512 and the estimated probabilities of whether or not the user subsequently books the search-result flight can be thought of, as discussed above, as a column vector P_{B} 1514. The constant value and the weights can be considered to be a second column vector W 1516. Multiplication of the matrix X by the column vector W produces the column vector P_{B}, according to the model 1502 and 1504. A least-squares fitting procedure, represented by equation 1518, can be used to generate values for the weights from the observed search results. Note that the user_id attribute is not used, so that the model models a generalized user, and that all search results are used to generate a reasonable set of weights. This procedure assumes numeric values for the attributes, but, of course, non-numeric attribute values can be converted into numeric attribute values, and additional complexities with regard to discrete-valued attributes, mixed floating-point and integer values, and other representational issues are generally straightforwardly handled. There are many possible ways to model how the attribute values of the search results determine whether or not flights are booked, and many corresponding methods for generating model functions that encapsulate these models from the observed data. This procedure also assumes that the attributes are independent from one another. In the case that the attributes may be interdependent, a covariance matrix can be employed in place of the reduced-observation matrix, in certain approaches.

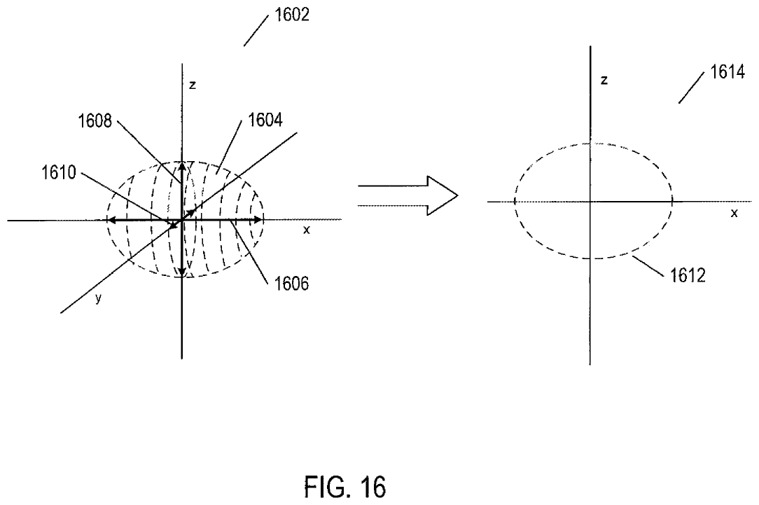

FIG. 16 illustrates dimensional reduction. In the simplistic model discussed above with reference to FIG. 15, there may be many different attributes associated with a given flight returned as a search result. The method for computing weights for the example model function involves determining the inverse of a large matrix, and, as the number of attributes increases, the matrix-inversion operation becomes exponentially more computationally expensive. Other types of model-generation techniques also suffer from rapidly increasing computational complexity with respect to the number of attributes considered. Furthermore, regardless of the method, including too many attributes in the model may be result in noisy and inaccurate predictions. Therefore, it is common to employ various different types of methods to identify those attributes that contribute the greatest explanatory power for the model, so that only those attributes are used for model generation, with the remaining attributes disregarded. As one example, the distribution of data points for a set of observations that each includes three attribute values may be plotted as a volume in three dimensions, since each observation corresponds to a point in three-dimensional space. In an example three-dimensional plot 1602 of such data points, all of the points corresponding to the observations fall within an ellipsoidal volume 1604. The ellipsoid has a major axis 1606 in the x-attribute correction, a minor axis 1608 in the z-attribute direction, and a very short minor axis 1610 in the y-attribute direction. In this case, much of the variability in the data points within the three-dimensional ellipsoid volume 1604 can be explained using only the x and z attributes. Projecting the three-dimensional ellipsoidal volume 1604 onto the xz plane produces a two-dimensional ellipse 1612 shown in two-dimensional plot 1614. Thus, the original three-dimensional observation space can be reduced to a two-dimensional observation space that captures much of the data variability present in the original three-dimensional observation space. There are many techniques for dimensionally reducing problem domains, such as the problem domain discussed above with reference to FIG. 10. Many assume real-valued attributes, such as the principal-component-analysis method, but other methods can be used for mixed-value-type observation data. Thus, initial data analysis can be used to determine the most significant attributes for any particular predictive model based on the information collected and stored by the currently disclosed flight-recommendation-and-booking system.

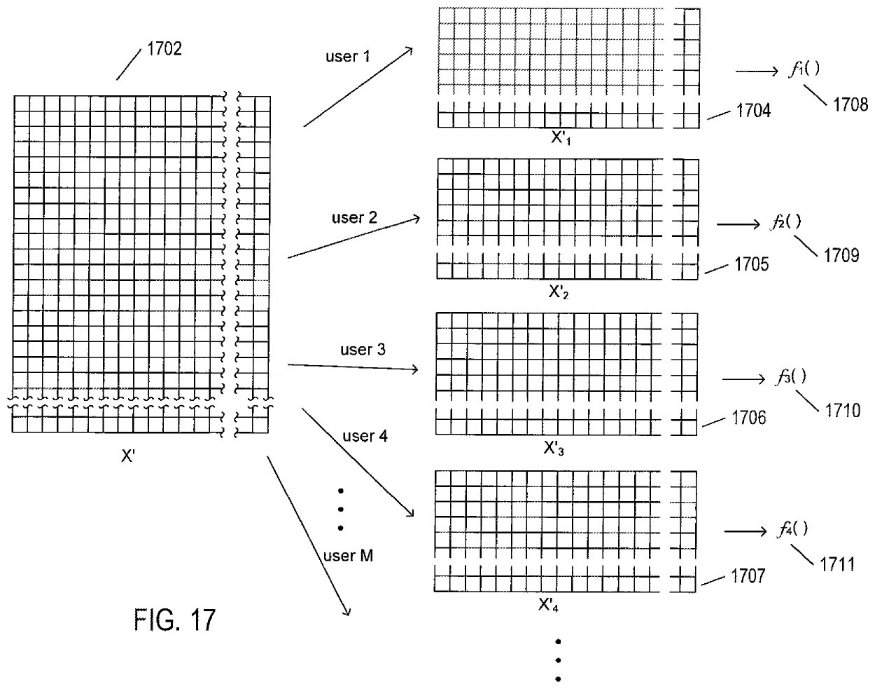

FIG. 17 illustrates generating individual models for each user of the currently disclosed flight-recommendation-and-booking system. As discussed above, following dimensional analysis, the set of observations can be dimensionally reduced to generate a matrix of reduced observations X′ 1702. Then, using the user_id attribute originally associated with the observations, the reduced observations X′ can be partitioned into a set of user-specific reduced-observation matrices 1704-1707. Each of these user-specific reduced-observation matrices can then be used to generate a user-specific model function 1708-1711. In many cases, the model-function weights generated by using all of the dimensionally reduced observations for the model for a generalized user can be used as a starting point for generation of each user-specific model function. Thus, each user of the currently disclosed flight-recommendation-and-booking system can be associated with one or more predictive models that each predicts a user's individual response to various information provided to them by the flight-recommendation-and-booking system or, in other words, that reflect the user's preferences and travel-decision-making process. In the current example, each user-specific model predicts the probability that the user would book a flight associated with a given set of attribute values. Many other types of models may predict other types of user behavior with respect to other types of information provided to them by the currently disclosed flight-recommendation-and-booking system.

In many cases, when sufficient data in unavailable, models for different classes or sets of users with common behaviors can be initially generated, so that simulation can be based on models for various classes of users, rather than on individual users. Alternatively, mixed-model simulations may include user-class models as well as individual user models. In the above example, the dimensional reduction is carried out across all of the data, but, in alternative methods, when justified by sufficient data, dimensional reduction may be carried out on the data corresponding to user classes or individual users. In many implementations, a first threshold number of observations in the observed data set for search results and bookings related to a particular user is needed to generate an accurate predictive model for the particular user and a second threshold number of observations in the observed data set for search results and bookings related to a particular user class is needed to generate an accurate predictive model for the particular user class.

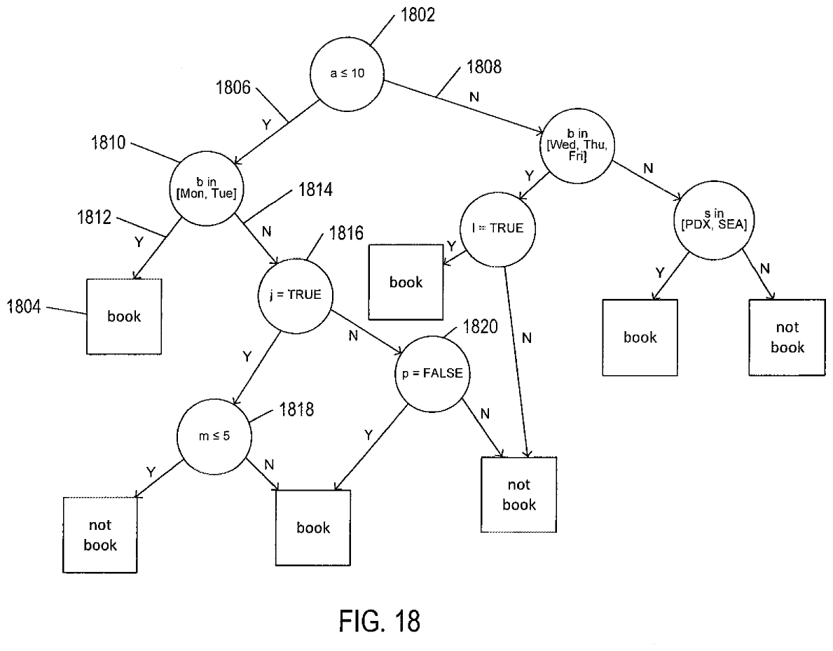

FIG. 18 shows an alternative type of predictive model for user behavior. In order to generate good predictive models for user behavior of the type discussed above with reference to FIG. 15, a relatively large set of user-specific observations needs to be available. When there is insufficient stored data for generating this type of model, other types of models can be generated that still provide reasonable predictions of future user behavior. One such type of model is a decision tree. FIG. 18 shows an example decision tree that can be used to determine whether or not a particular user would book a flight associated with a particular set of attribute values. The circular nodes in the decision tree, such as circular nodes 1802, represent some type of test carried out on a particular attribute value, such as a threshold-value evaluation. Rectangular nodes, such as rectangular node 1804, represent predictions of user behavior. The tree is traversed from the root node 1802 down to a prediction note. For example, at the root-node level, the value of an attribute a is compared to the numeric value 10. If the value of the attribute a is less than or equal to 10, then the left-hand branch 1806 is taken. Otherwise, the right-hand branch 1808 is taken. In the case that the value of attribute a is less than or equal to 10, the value of the attribute b is then tested, as represented by circular nodes 1810. If the value of attribute b is “Monday” or “Tuesday,” the left-hand branch 1812 is taken, resulting in a determination that the user would book the flight. Otherwise, the right-hand branch 1814 is taken, leading to two more additional attribute-value tests represented by circular nodes 1816 and I of circular nodes 1818 and 1820. There are many well-known methods for generating decision trees from collected user-behavior data. Decision trees may also be used to model user classes.

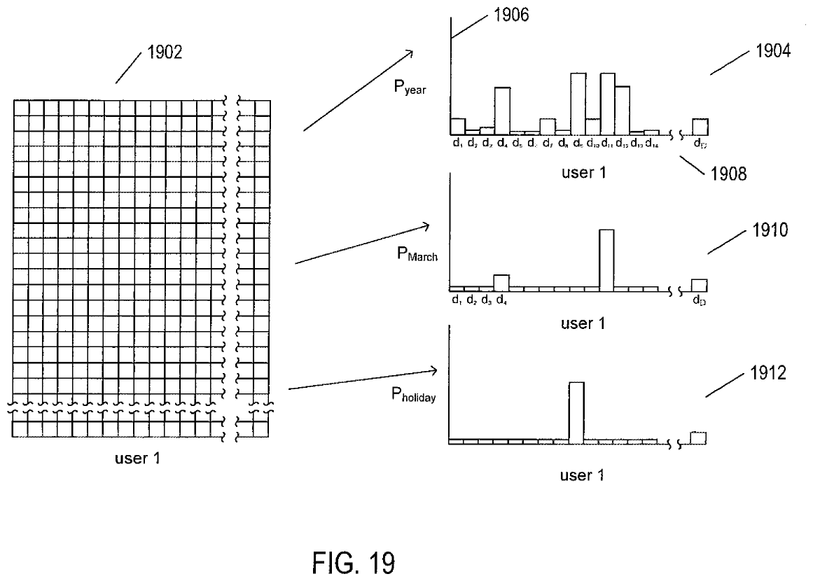

FIG. 19 illustrates generation of probability-density functions. The accumulated data relevant to a particular user 1902 can be used to generate probability-density functions, in the discrete-valued-attribute case representable as histograms, with respect to various types of user behaviors. For example, as shown in FIG. 19, the accumulated data can be used to generate a histogram 1904 representing the probability, plotted with respect to vertical axis 1906, that a particular user will book a flight to each of the possible destinations represented by the horizontal axis 1908. Similarly, the accumulated data relevant to a particular user can be used to generate a histogram 1910 representing the probabilities that a particular user will book a flight to each of a set of destinations during the month of March. As another example, the accumulated data relevant to a particular user can be used to generate a histogram 1912 representing the probabilities that a particular user will book a flight to each of a set of destinations during a holiday. These user-specific probability-density functions are yet additional types of models of user and user-class behaviors.

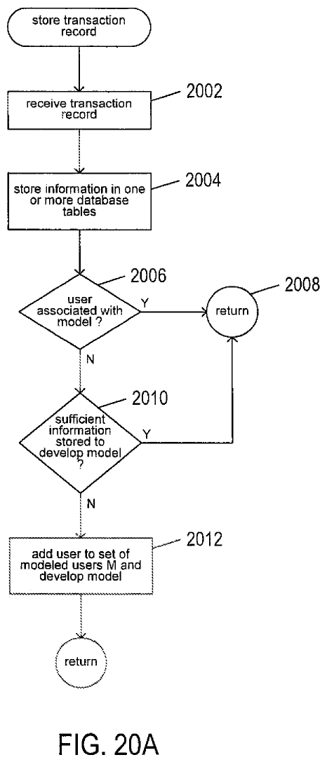

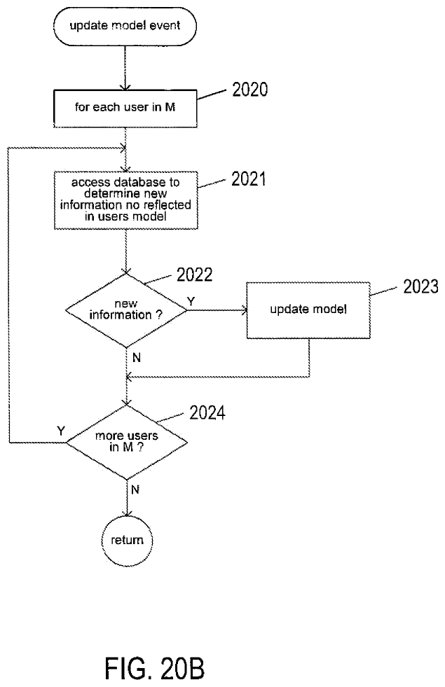

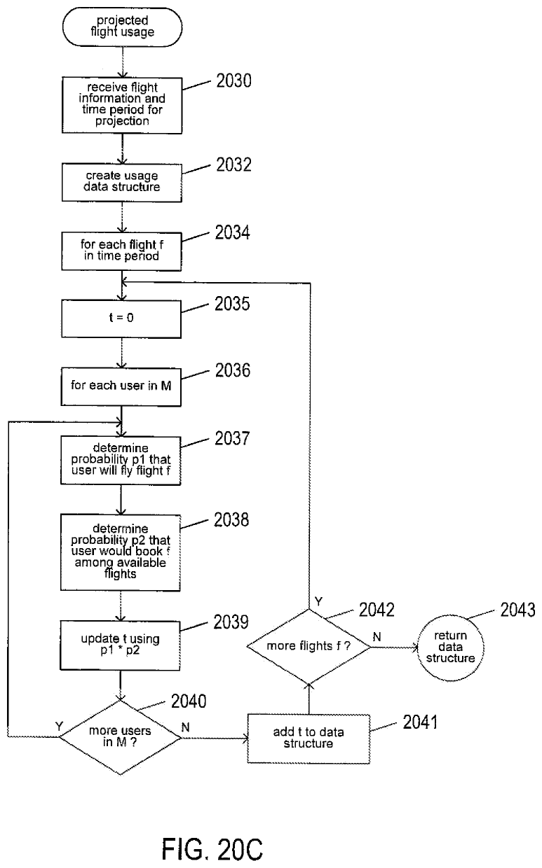

FIGS. 20A-C provide control-flow diagrams that illustrate how the currently disclosed flight-recommendation-and-booking system can provide accurate predictions of aggregate consumer behavior. FIG. 20A provides a control-flow diagram that shows additional detail for the operation of storing a transaction record, previously discussed with reference to steps 989-990 in FIG. 9G. In step 2002, the routine “store transaction record” receives a transaction record to store. In step 2004, the routine stores information extracted from the transaction record in one or more database tables. In step 2006, the routine determines whether or not the user for which the transaction record was generated is currently associated with one or more predictive models, such as those discussed above with reference to FIGS. 15-19. If so, the routine terminates 2008. Otherwise, in step 2010, the routine determines whether or not there is now sufficient information stored in the database from which to develop one or more predictive models for the user. If not, the routine terminates 2008. Otherwise, in step 2012, the routine adds the user to a set M of modeled users and develops the one or more predictive models for the user. Step 2012 may, of course, be carried out asynchronously with respect to processing of the user request with respect to which the transaction record was generated. Thus, the flight-recommendation-and-booking engine continuously adds users to the set M of modeled users as sufficient data becomes available. Of course, in similar fashion, the flight-recommendation-and-booking engine may also remove users from the set M of modeled users when they fail to generate sufficient timely stored information, so that the set M of modeled users reflects a set of users currently using the flight-recommendation-and-booking system to find and book flights.

FIG. 20B illustrates an update-models-event handler that periodically updates the user models maintained by the currently disclosed flight-recommendation-and-booking system. In the for-loop of steps 2020-2024, the update-models-event handler considers each user in the set M of modeled users. In step 2021, the update-models-event handler determines whether or not there is new information stored in the database for the currently considered user that is not reflected in the one or more predictive models maintained for the user. If so, as determined in step 2022, the predictive models are updated in step 2023. Of course, the update-models-event handler may additionally determine that certain of the information on which the current models are based has become stale, and may then update the models to remove the influence of the stale information from the models.

FIG. 20C provides a control-flow diagram for a projected-flight-usage routine that returns information from which an analyst may determine how airline consumers will respond to a newly offered flight. In step 2030, the projected-flight-usage routine receives information about the newly offered flight, in the form of attribute values, as well as a time for the projected consumer demand. In step 2032, the projected-flight-usage routine creates a usage data structure. Then, in the outer for-loop of steps 2034-2042, for each instance ƒ of the flight offered during the time period, the projected-flight-usage routine determines a projected number of bookings of the flight from among the users in the set M. In step 2035, a local variable t representing the projected number of bookings is set to 0. Then, in each iteration of the inner for-loop of steps 2036-2040, the projected-flight-usage routine determines, in step 2037, the probability p1 that a particular user will fly the route represented by flight ƒ, then determines, in step 2038, the probability p2 that the particular user would book of the flight ƒ from among all flights offered for that route, and uses the two probabilities to update the projected number of bookings stored in the local variable t. Following completion of the inner for-loop of steps 2036-2040, the value stored in local variable t is added to the usage data structure, in step 2041. The usage data structure is returned in step 2043, following completion of the outer for-loop of steps 2034-2042.

The above-discussed example of predicting the consumer response to a newly offered flight is but one of many different possible examples of predicting consumer behavior based on the types of data collected and stored by the currently disclosed flight-recommendation-and-booking system. One fundamental idea is that the currently disclosed flight-recommendation-and-booking system collects and stores amounts and types of information sufficient to individually model the behaviors of multiple users and/or user classes. These models allow for modeling-based and simulation-based prediction of future aggregate user behavior, such as the number of users who would likely book a newly offered flight on a particular day, within a particular month, or during a particular year, as three examples. Then, knowing the fraction of the total market represented by the users, the system is able to provide accurate predictions of the total demand for the newly offered route. General statistical data based on aggregate user behavior, such as information about the total number of users who fly particular routes over periods of time, does not provide the predictive power provided by using individual models for individual consumers, disclosed in the current document. As an example, general statistical information can be used for systems such as aggregations of molecules to accurately predict aggregate parameters, such as temperature, pressure, rate of flow, and other such parameters and model systems. This is because the aggregate behaviors of the molecules have been empirically found, and later theoretically shown, to be well modeled as a function of only a few parameters. Molecules do not make complicated choices, but respond somewhat deterministically and uniformly to changes in these parameters. By contrast, humans make complex decisions that are influenced by many different parameters, as a result of which predictions of aggregate human behavior based on a limited number of attribute values are often of relatively low reliability and accuracy. By contrast, when specific user information is collected and used to generate models for the behavior and likely choices of individual users, these multiple models can be used to simulate aggregate behavior of the users with significantly greater reliability and accuracy. Because the currently disclosed flight-recommendation-and-booking system is able to store a great many observations, each associated with many different attributes, for each individual user, the currently disclosed flight-recommendation-and-booking system is able to produce and maintain relatively accurate models of individual users' behaviors, from which aggregate user behaviors can be reliably simulated. Simulations can then be carried out on any number of hypothetical scenarios to provide predictions of aggregate user behavior, given the hypothetical scenarios. The currently disclosed flight-recommendation-and-booking system thus becomes an extremely valuable tool for airlines, business analysts, and other such users to predict airline-consumer behaviors in response to a variety of different market changes, such as the addition of new flights, addition of new types of services and amenities, changes in flight schedules, and other such market changes. Of course, far more complex and realistic models that that model interdependencies among attributes and among users than those used as examples in the current document can be developed to provide reliable and accurate predictions of aggregate consumer behavior.

Although the present invention has been described in terms of particular embodiments, it is not intended that the invention be limited to these embodiments. Modification within the spirit of the invention will be apparent to those skilled in the art. For example, any of a variety of different implementations of the currently disclosed methods and systems can be obtained by varying any of many different design and implementation parameters, including modular organization, programming language, underlying operating system, control structures, data structures, and other such design and implementation parameters. As discussed above, many different types of attributes and preferences may be considered for generating flight recommendations, in addition to those discussed above, and many additional types of information may be monitored and stored.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An automated flight-recommendation-and-booking system comprising:
one or more computers within a cloud-computing facility, data center, or one or more Internet-connected servers, each having one or more processors and one or memories;
one or more data-storage devices and/or data-storage appliances:
stored information about users, user preferences, flights, attributes, and other information relevant to air travel that is stored in one or more of the one or more data-storage devices and/or appliances; and
computer instructions, stored in one or more of the one or more memories, one or more data-storage devices, and data-storage appliances that, when executed by one or more of the one or more processors, control the automated flight-recommendation-and-booking system to
continuously monitor sources of information relevant to air travel to identify information for updating the stored information,
receive user requests for flight recommendations,
in response to each received user request for flight recommendations,
identify and return information about a small number of flights that best match a user's preferences,
receive flight-booking requests,
in response to each received flight-booking requests,
book a flight on behalf of a user,
update the stored information to accurately reflect the user's preferences, generate models for users' preferences and travel-decision-making processes, and
use the generated models to predict aggregate user responses to hypothetical market scenarios.

2. The automated flight-recommendation-and-booking system of claim 1 wherein the automated flight-recommendation-and-booking system generates models for users' preferences and travel-decision-making processes by:
retrieving, from the stored information, values of multiple attributes related to flights returned as search results to users of the system as a first set of observations:
retrieving, from the stored information, indications of whether or not the retrieved flight search results were booked by the users to whom they were returned as search results as a second set of observations;
generating a general observed data set from the retrieved first set of observations and second set of observations;
partitioning the general observed data set into multiple specific observed data sets; and
generating multiple predictive models from the multiple specific observed data sets.

3. The automated flight-recommendation-and-booking system of claim 2 wherein generating a general observed data set from the retrieved first set of observations and second set of observations further comprises:
using dimensional reduction to identify a reduced set of explanatory attributes in the general observed data set; and
generating, from the general observed data set, a reduced observed data set that includes values for the reduced set of explanatory attributes.

4. The automated flight-recommendation-and-booking system of claim 3 wherein partitioning the general observed data set into multiple specific observed data sets further comprises:
partitioning the reduced observed data set into multiple specific observed data sets.

5. The automated flight-recommendation-and-booking system of claim 4 wherein generating multiple predictive models from the multiple specific observed data sets further comprises:
initially partitioning the reduced observed data set into specific observed data sets for each of which more than a threshold number of observations are included in the reduced observed data set to generate a predictive model; and
iteratively generating additional specific observed data sets as more observations are included, over time, in the reduced observed data set.

6. The automated flight-recommendation-and-booking system of claim 3 wherein specific observed data sets include:
user-specific observed data sets; and
user-class-specific data sets.

7. The automated flight-recommendation-and-booking system of claim 4 wherein generating a predictive model from a specific observed data set further comprises:
generating, using matrix-inversion-based least squares, a predictive-model function ƒ that takes, as arguments, values for each of the explanatory attributes and that returns a probability of booking;
generating a decision tree; and
generating one or more probability-density functions.

8. The automated flight-recommendation-and-booking system of claim 7 wherein using the generated models to predict aggregate user responses to hypothetical market scenarios further comprises:
receiving information about a set of newly offered flights, including a set of attribute values and a time for a projected consumer demand;
initializing a usage data structure; and
iteratively adding projected numbers of flight bookings to the usage data structure.

9. The automated flight-recommendation-and-booking system of claim 8 wherein iteratively adding projected numbers of flight bookings to the usage data structure further comprises:
for each flight in the set of newly offered flights,
determining a projected number of flight bookings for the flight, and
adding the projected number of flight bookings to the usage data structure.

10. The automated flight-recommendation-and-booking system of claim 9 wherein determining a projected number of flight bookings for the flight further comprises:
setting a projected-number-of-flight-bookings variable to 0;
for each of a set of predictive models generated from a specific observed data set,
using the predictive model to generate a flight-selection probability,
using the predictive model to generate a relative booking probability, and
updating the projected-number-of-flight-bookings variable using the product of the flight-selection probability and the relative booking probability.

11. A method that predicts aggregate user responses to hypothetical commercial-flight market scenarios, the method comprising:
obtaining a general observed data set from an automated flight-recommendation-and-booking system;
generating models for users' preferences and travel-decision-making processes; and
using the generated models to predict aggregate user responses to hypothetical market scenarios.

12. The method of claim 11 wherein obtaining a general observed data set from an automated flight-recommendation-and-booking system and generating models for users' preferences and travel-decision-making processes further comprises:
retrieving, from stored information, values of multiple attributes related to flights returned as search results to users of the system as a first set of observations;
retrieving, from the stored information, indications of whether or not the retrieved flight search results were booked by the users to whom they were returned as search results as a second set of observations;
generating the general observed data set from the retrieved first set of observations and second set of observations;
partitioning the general observed data set into multiple specific observed data sets; and
generating multiple predictive models from the multiple specific observed data sets.

13. The method of claim 12 wherein generating a general observed data set from the retrieved first set of observations and second set of observations further comprises:
using dimensional reduction to identify a reduced set of explanatory attributes in the general observed data set; and
generating, from the general observed data set, a reduced observed data set that includes values for the reduced set of explanatory attributes.

14. The method of claim 13 wherein partitioning the general observed data set into multiple specific observed data sets further comprises:
partitioning the reduced observed data set into multiple specific observed data sets.

15. The method of claim 14 wherein generating multiple predictive models from the multiple specific observed data sets further comprises:
initially partitioning the reduced observed data set into specific observed data sets for each of which more than a threshold number of observations are included in the reduced observed data set to generate a predictive model; and
iteratively generating additional specific observed data sets as more observations are included, over time, in the reduced observed data set.

16. The method of claim 15 wherein specific observed data sets include:
user-specific observed data sets; and
user-class-specific data sets.

17. The method of claim 14 wherein generating a predictive model from a specific observed data set further comprises:
generating, using matrix-inversion-based least squares, a predictive-model function ƒ that takes, as arguments, values for each of the explanatory attributes and that returns a probability of booking;
generating a decision tree; and
generating one or more probability-density functions.

18. The method of claim 17 wherein using the generated models to predict aggregate user responses to hypothetical market scenarios further comprises:
receiving information about a set of newly offered flights, including a set of attribute values and a time for a projected consumer demand;
initializing a usage data structure; and
iteratively adding projected numbers of flight bookings to the usage data structure.

19. The method of claim 18 wherein iteratively adding projected numbers of flight bookings to the usage data structure further comprises:
for each flight in the set of newly offered flights,
determining a projected number of flight bookings for the flight, and
adding the projected number of flight bookings to the usage data structure.

20. The method of claim 19 wherein determining a projected number of flight bookings for the flight further comprises:
setting a projected-number-of-flight-bookings variable to 0;
for each of a set of predictive models generated from a specific observed data set,
using the predictive model to generate a flight-selection probability,
using the predictive model to generate a relative booking probability, and
updating the projected-number-of-flight-bookings variable using the product of the flight-selection probability and the relative booking probability.
